(19) United States
(12) Patent Application Publication
(10) Pub. No.: US 2025/0167527 A1
(43) Pub. Date: May 22, 2025

(54) RETRACTING AND EXTENDING APPARATUS AND CART APPARATUS TRANSPORTING SAME

(71) Applicant: LS ELECTRIC CO., LTD., Anyang-si, Gyeonggi-do (KR)

(72) Inventor: Min Kyu SEO, Anyang-si, Gyeonggi-do (KR)

(21) Appl. No.: 18/841,452

(22) PCT Filed: Jan. 25, 2023
(86) PCT No.: PCT/KR2023/001084

§ 371 Date: Aug. 26, 2024

(30) Foreign Application Priority Data
Apr. 19, 2022 (KR) 10-2022-0048143

(51) Int. Cl. H02B 11/173; H01F 7/02; H02B 11/127

(52) U.S. Cl. CPC H02B 11/173; H01F 7/0231; H02B 11/127

(57) ABSTRACT

A draw in and out apparatus and a cart apparatus transporting the same are disclosed. A draw in and out apparatus according to an aspect of the present disclosure may include a first support unit detachably coupled to an external distribution board; a second support unit movably coupled to the first support unit; a third support unit movably coupled to the second support unit; and a power unit detachably coupled to the third support unit, and configured to be coupled to or detachable from an external circuit breaker, wherein the power unit includes a key withdrawably accommodated in an insertion space provided in the circuit breaker; and a motor member coupled to the key and configured to rotate the inserted key in any one direction of the clockwise direction and counterclockwise direction.

### CROSS-REFERENCE TO RELATED APPLICATIONS

This application is the National Stage filing under 35 U.S.C. 371 of International Application No. PCT/KR2023/001084, filed on Jan. 25, 2023, which claims the benefit of earlier filing date and right of priority to Korean Application No. 10-2022-0048143, filed on Apr. 19, 2022, the contents of which are all hereby incorporated by reference herein in their entirety.

### FIELD

The present disclosure relates to a draw in and out apparatus and a cart apparatus transporting the same, and more particularly, to a draw in and out apparatus for easily drawing a circuit breaker into a distribution board or easily drawing it out from a distribution board, and a cart apparatus for transporting the same.

### BACKGROUND

A distribution board refers to an apparatus that transmits electricity received from an external power source to the load according to the system or purpose. The distribution board is energized with an external power source and load, respectively, and energizes the external power source and load.

To prevent power failures that may occur between external power sources and loads, distribution boards are usually equipped with circuit breakers. The circuit breaker is configured to be energizably connected to an external power source and load, respectively, and to cut off abnormal current when it occurs. Accordingly, the above power accident can be prevented.

If a current breaking operation is performed, replacement of the circuit breaker's components may be required. It can also be assumed that the circuit breaker must be removed from the distribution board for maintenance of the circuit breaker. Thus, it is common for the circuit breaker to be detachably coupled to the distribution board.

Meanwhile, the size of the distribution board and circuit breaker tends to be proportional to its rated capacity. That is, when a larger current is applied, the size of the circuit breaker for breaking it may increase. Accordingly, the size of the distribution board to which the circuit breaker is coupled may also be increased. Therefore, a large force is required for the circuit breaker to be coupled to or separated from the distribution board.

However, in the case of traditional structure distribution boards and circuit breakers, the process of connecting and disconnecting the circuit breakers is performed manually. That is, the above process is usually performed by an operator. Therefore, the accuracy and efficiency of the circuit breaker's connecting and disconnecting operations may be reduced. Furthermore, it is difficult to rule out the possibility of a safety accident occurring during the process of connecting and disconnecting heavy circuit breakers.

Korean Registered Patent Document No. 10-1733705 discloses a distribution board equipped with a vacuum circuit breaker draw in and out safety apparatus. Specifically, it discloses a distribution board equipped with a vacuum circuit breaker draw in and out safety apparatus, which has a locking groove provided on the bottom of a transport truck on which a vacuum circuit breaker is seated, and prevents arbitrary movement of the vacuum circuit breaker by locking or releasing the locking groove by a horizontal plate provided on a cradle.

However, the distribution board equipped with a vacuum circuit breaker draw in and out safety apparatus disclosed in the above-mentioned prior document assumes that the vacuum circuit breaker is manually drawn in and out from the distribution board. That is, the above prior document does not present a method for automatically performing the draw in and out process of a vacuum circuit breaker.

Korean Registered Patent Document No. 10-1912449 discloses a high-voltage distribution board with a remote racking system applied. Specifically, it discloses a high voltage distribution board having a remote racking system applied thereto, which enables draw in and out of circuit breakers within the high voltage distribution board in a remote form.

However, the high-voltage distribution board to which the remote racking system is applied, disclosed in the above-mentioned prior art document must have an actuator for moving the circuit breaker installed within the high-voltage distribution board. That is, additional motors are installed inside high-voltage distribution boards that include complex and diverse configurations, and additional complex wiring structures are required to control them.

Furthermore, the remote racking system disclosed in the above prior art document has complexly configured conditions for moving the circuit breaker. Therefore, since the control signal for the draw in or out of the circuit breaker must be input precisely, it is difficult for the draw in or out process of the circuit breaker to be performed smoothly.
Korean Patent Registration No. 10-1733705 (2017 May 8)
Korean Patent Registration No. 10-1912449 (2018 Oct. 26)

### SUMMARY

The present disclosure is to solve the above problems, and the present disclosure is directed to providing a draw in and out apparatus having a structure that facilitates the drawing in and out process of a circuit breaker for a distribution board, and a cart apparatus for transporting the same.

The present disclosure is also directed to providing a draw in and out apparatus having a structure that is easy to move and install, and a cart apparatus for transporting the same.

The present disclosure is also directed to providing a draw in and out apparatus having a structure in which heavy components can be stored or moved separately, and a cart apparatus for transporting the same.

The present disclosure is also directed to providing a draw in and out apparatus having a structure that can be easily coupled to or separated from a distribution board, and a cart apparatus for transporting the same.

The present disclosure is also directed to providing a draw in and out apparatus having a structure in which the drawing in and out process of a circuit breaker can be performed remotely, and a cart apparatus for transporting the same.

The present disclosure is also directed to providing a draw in and out apparatus having a structure whose size can be changed to correspond to a distribution board or a circuit breaker, and a cart apparatus for transporting the same.

The problems of the present disclosure are not limited to those mentioned above, and other problems not mentioned will be clearly understood by those of ordinary skill in the art from the following description.

According to an aspect of the present disclosure, provided is a draw in and out apparatus, including a first support unit detachably coupled to an external distribution board: a second support unit movably coupled to the first support unit: a third support unit movably coupled to the second support unit; and a power unit detachably coupled to the third support unit, and configured to be coupled to or detachable from an external circuit breaker, wherein the power unit includes a key withdrawably accommodated in an insertion space provided in the circuit breaker; and a motor member coupled to the key and configured to rotate the inserted key in any one direction of the clockwise direction and counterclockwise direction.

In this case, a draw in and out apparatus may be provided in which the third support unit includes a bar member that is movably coupled to the second support unit and formed to extend along one direction; and an adjustment member movably coupled to the bar member and to which the power unit is fixedly coupled, and the power unit is coupled to the bar member to be movable along the one direction together with the adjustment member.

In addition, a draw in and out apparatus may be provided in which the adjustment member includes an adjustment body arranged to face the power unit with the bar member therebetween and fixedly coupled to the power unit; and an adjustment guide disposed on the inner surface of the adjustment body and movably inserted into one of a plurality of bar hollows formed in the bar member.

In this case, a draw in and out apparatus may be provided in which the draw in and out apparatus includes a fastening member that detachably connects the adjustment body and the power unit.

In addition, a draw in and out apparatus may be provided in which the adjustment member includes an adjustment extension penetrating the adjustment body and extending to another one of the plurality of bar hollows; and an adjustment dial coupled to the adjustment extension, exposed to the outside of the adjustment body, and rotatably provided so as to move together with the adjustment extension in a direction toward the bar hollow and in a direction opposite to the bar hollow.

In this case, a draw in and out apparatus may be provided in which the first support unit includes a column member surrounding a portion of the circuit breaker accommodated in the distribution board: a plate member coupled to the column member and surrounding another portion of the circuit breaker; and a magnet member that is coupled to the plate member and forms a magnetic force so as to be detachably coupled to the distribution board.

In addition, a draw in and out apparatus may be provided in which the first support unit includes a handle member coupled to the magnet member and configured to adjust the magnitude of a magnetic force formed by the magnet member by being operated by an external force.

In this case, a draw in and out apparatus may be provided in which when the handle member is rotated in any one direction of the clockwise direction and the counterclockwise direction, the magnitude of the magnetic force formed by the magnet member increases, so that the magnet member is coupled to the distribution board, and when the handle member is rotated in the other direction of the clockwise direction and the counterclockwise direction, the magnitude of the magnetic force formed by the magnet member decreases, so that the magnet member is separated from the distribution board.

In addition, a draw in and out apparatus may be provided in which a pair of said column members are provided, and the pair of column members are disposed to be spaced apart from each other, and the plate member is formed to extend as far as a distance at which the pair of column members are spaced apart.

In this case, a draw in and out apparatus may be provided in which the second support unit includes a partition wall member movably coupled to the column member; and a beam member that is coupled to the partition wall member to move together with the partition wall member and movably supports the third support unit.

In addition, a draw in and out apparatus may be provided in which a pair of said beam members are provided, and the pair of beam members are disposed to be spaced apart from each other, and the partition wall member is formed to extend as far as a distance at which the pair of beam members are spaced apart.

In this case, a draw in and out apparatus may be provided in which the third support unit includes a bar member movably coupled to the beam member and extending in a direction opposite to the circuit breaker; and a support member coupled to an end in the extension direction of the bar member.

In addition, a draw in and out apparatus may be provided in which a pair of said bar members are provided, and the pair of bar members are disposed to be spaced apart from each other, and the support member is formed to extend as far as a distance at which the pair of bar members are spaced apart.

In addition, according to an aspect of the present disclosure, provided is a cart apparatus configured to be moved with loading a plurality of support units and a power unit that is detachably coupled to one of the plurality of support units, the cart apparatus including a cart body: a support plate forming one side of the cart body and supporting the power unit; and an apparatus support portion formed to extend outward from the other side of the cart body and penetrate through the plurality of support units coupled to each other to support a portion thereof.

In this case, a cart apparatus may be provided in which the power unit includes a motor member; a key coupled to the motor member to rotate together; and a remote controller configured to be energized with the motor member and to receive a control signal, and a utility accommodation portion in which a plurality of openings are formed through which the motor member, the key, and the remote controller pass, respectively, is disposed in the support plate.

According to the above configuration, the draw in and out apparatus and the cart apparatus including the same according to an exemplary embodiment of the present disclosure can facilitate the drawing in and out process of the circuit breaker to the distribution board.

The draw in and out apparatus is equipped with a power unit. The power unit is equipped with a motor member that is rotated by an external power source. The motor member includes a shaft and a key coupled to the shaft and rotated together. The key can be accommodated in or drawn out from an insertion space formed in the circuit breaker.

When the motor member is operated, the key is rotated clockwise or counterclockwise while being accommodated in the insertion space. Accordingly, members provided adjacent to the insertion space of the circuit breaker are rotated together, so that the circuit breaker can be drawn into or drawn out from the distribution board.

Therefore, the process of drawing in and out of the circuit breaker can be performed by the operation of the power unit. As a result, the process of coupling and separating the circuit breaker and the distribution board may proceed even if manual work of an operator is not involved.

In addition, according to the above configuration, the draw in and out apparatus and the cart apparatus including the same according to an exemplary embodiment of the present disclosure can be easily moved and installed.

Each component of the draw in and out apparatus can be detachably coupled. In particular, the power unit formed to have a high weight is detachably coupled to the third support unit and can be moved together with the third support unit. Specifically, the power unit is fixedly coupled to the adjustment member, and the adjustment member is movably coupled to the bar member. Accordingly, the power unit can be moved along the bar member.

Therefore, when the draw in and out apparatus is moved, other components of the draw in and out apparatus and the power unit can be moved separately from each other. In this case, the cart apparatus provided to transport the draw in and out apparatus is provided separately with a part accommodating the other components above and a part accommodating the power unit.

Furthermore, when the draw in and out apparatus is installed on the distribution board, other components other than the power unit can be installed on the distribution board first, and then the power unit can be coupled to the adjustment member. Therefore, it is not necessary to install a high-weight power unit at the same time, and thus ease of installation can be increased.

In addition, according to the above configuration, in the draw in and out apparatus and the cart apparatus including the same according to an exemplary embodiment of the present disclosure, heavy components can be stored or moved separately.

As described above, the high-weight power unit is provided detachably from the draw in and out apparatus. The cart apparatus includes a support plate and a utility accommodation portion for separately accommodating each component of the power unit, that is, the motor member, the key, the control device, and the remote controller.

Furthermore, the cart apparatus includes an apparatus support portion and an apparatus coupling portion for supporting other components except for the power unit among the components of the draw in and out apparatus.

Therefore, high-weight components among the components of the draw in and out apparatus can be separately managed, making it easier to move, assemble, and maintain the draw in and out apparatus.

In addition, according to the above configuration, the draw in and out apparatus and the cart apparatus including the same according to an exemplary embodiment of the present disclosure can be easily coupled to or separated from the distribution board.

The draw in and out apparatus includes a magnet member for forming a magnetic force. The magnitude of the magnetic force formed by the magnet member can be adjusted by the handle member. That is, as the handle member is operated by an external force, the magnitude of the magnetic force can be adjusted.

A plurality of magnet members can be provided. The plurality of magnet members can be disposed at different positions, so that the draw in and out apparatus can be coupled to the distribution board at a plurality of positions.

As described above, the high-weight power unit is detachably provided. Therefore, after other components except for the high-weight power unit are coupled to the distribution board by the magnet member, the power unit can be provided in the draw in and out apparatus.

When the power unit is operated after being coupled to the circuit breaker, the circuit breaker can be drawn into or drawn out from the distribution board.

In the case of separating the draw in and out apparatus, the high-weight power unit can be separated first, and then the other components can be separated from the distribution board. In this case, the magnitude of the magnetic force formed by the magnet member by operating the handle member is also adjusted so that the draw in and out apparatus and the distribution board can be separated.

Therefore, the draw in and out apparatus can be easily coupled to or separated from the distribution board.

In addition, according to the above configuration, the draw in and out apparatus and the cart apparatus including the same according to an exemplary embodiment of the present disclosure can remotely proceed with the drawing in and out process of the circuit breaker.

The power unit includes a remote controller energized with the motor member. The remote controller is energized with the motor member through the control device. An operator can control the operation of the motor member by inputting a control signal to the remote controller while being spaced apart from the power unit.

Therefore, the drawing in and out process of the circuit breaker can be performed by an operator physically spaced apart from the circuit breaker. As a result, any safety accidents that may occur during the drawing in and out process of the circuit breaker can be prevented.

In addition, according to the above configuration, the size of the draw in and out apparatus and the cart apparatus including the same according to an exemplary embodiment of the present disclosure can be changed to correspond to the distribution board or the circuit breaker.

The draw in and out apparatus includes a plurality of support units movably coupled to each other. The plurality of support units include a plurality of column members, a plurality of beam members, and a plurality of bar members extending in different directions.

The plurality of column members are positioned adjacent to each other, but the separation distance thereof can be adjusted. A plate member extending corresponding to the separation distance are coupled to the plurality of column members to support the plurality of column members spaced apart from each other.

The plurality of beam members are positioned adjacent to each other, but the separation distance thereof can be adjusted. A partition wall member extending corresponding to the separation distance are coupled to the plurality of beam members to support the plurality of beam members spaced apart from each other.

The plurality of bar members are positioned adjacent to each other, but the separation distance thereof can be adjusted. A support member extending corresponding to the separation distance are coupled to the plurality of bar members to support the plurality of bar members spaced apart from each other.

Therefore, the size of the draw in and out apparatus can be adjusted by the separation distance between the plurality of column members, the plurality of beam members, and the plurality of bar members. As a result, the size of the draw in and out apparatus can be adjusted to correspond to the size of the distribution board or circuit breaker to which it is coupled by adjusting the separation distance between each of the above-mentioned members.

Advantageous effects of the present disclosure are not limited to the above-described effects, and should be understood to include all effects that can be inferred from the configuration of the disclosure described in the detailed description or claims of the present disclosure.

### BRIEF DESCRIPTION OF THE DRAWINGS

FIG. 1 is a perspective view illustrating a state in which a draw in and out apparatus according to an exemplary embodiment of the present disclosure is coupled to a distribution board.

FIG. 2 is a front view illustrating the draw in and out apparatus and the distribution board of FIG. 1.

FIG. 3 is a right side view illustrating the draw in and out apparatus and the distribution board of FIG. 1.

FIG. 4 is a perspective view illustrating a state in which the draw in and out apparatus of FIG. 1 is separated from the distribution board.

FIGS. 5 and 6 are perspective views illustrating the draw in and out apparatus of FIG. 1.

FIG. 7 is a front view illustrating the draw in and out apparatus of FIG. 1.

FIG. 8 is a right side view illustrating the draw in and out apparatus of FIG. 1.

FIG. 9 is a rear view illustrating the draw in and out apparatus of FIG. 1.

FIG. 10 is an exploded perspective view illustrating the draw in and out apparatus of FIG. 1.

FIG. 11 is a perspective view illustrating a first support unit provided in the draw in and out apparatus of FIG. 1.

FIGS. 12 and 13 are perspective views illustrating a second support unit provided in the draw in and out apparatus of FIG. 1.

FIG. 14 is a front view illustrating the second support unit of FIGS. 12 and 13.

FIGS. 15 and 16 are perspective views illustrating a third support unit and a power unit coupled thereto provided in the draw in and out apparatus of FIG. 1.

FIGS. 17 and 18 are exploded perspective views illustrating the third support unit and the power unit of FIGS. 15 and 16.

FIG. 19 is a perspective view illustrating a draw in and out apparatus according to another exemplary embodiment of the present disclosure.

FIG. 20 is a usage state diagram illustrating a process in which the position of a power unit provided in a draw in and out apparatus according to an exemplary embodiment of the present disclosure is adjusted along a first axis.

FIG. 21 is a usage state diagram illustrating a process in which the position of a power unit provided in a draw in and out apparatus according to an exemplary embodiment of the present disclosure is adjusted along a second axis.

FIG. 22 is a usage state diagram illustrating a process in which the position of a power unit provided in a draw in and out apparatus according to an exemplary embodiment of the present disclosure is adjusted along a third axis.

FIG. 23 is a perspective view illustrating a cart apparatus for transporting a draw in and out apparatus according to an exemplary embodiment of the present disclosure.

FIG. 24 is a usage state diagram illustrating a process in which a draw in and out apparatus is accommodated in the cart apparatus of FIG. 23.

### DETAILED DESCRIPTION

Hereinafter, exemplary embodiments of the present disclosure will be described in detail so that those of ordinary skill in the art can readily implement the present disclosure with reference to the accompanying drawings. The present disclosure may be embodied in many different forms and is not limited to the embodiments set forth herein. In the drawings, parts unrelated to the description are omitted for clarity of description of the present disclosure, and throughout the specification, same or similar reference numerals denote same elements.

Terms and words used in the present specification and claims should not be construed as limited to their usual or dictionary definition. They should be interpreted as meaning and concepts consistent with the technical idea of the present disclosure, based on the principle that inventors may appropriately define the terms and concepts to describe their own disclosure in the best way.

Accordingly, the embodiments described in the present specification and the configurations shown in the drawings correspond to preferred embodiments of the present disclosure, and do not represent all the technical idea of the present disclosure, so the configurations may have various examples of equivalent and modification that can replace them at the time of filing the present disclosure.

In the following description, in order to clarify the features of the present disclosure, descriptions of some components may be omitted.

### 1. Term Definition

The term “communication” used in the following description means that one or more members are connected to each other so as to be in fluid communication. In an embodiment, the communication may be formed by a member such as a conduit, a pipe, a tubing, or the like.

The term “energization or energizably connected” used in the following description means that one or more members are connected to each other so as to transmit an electric current or an electric signal. In an embodiment, the energization may be formed in a wired form by a wire member or the like or in a wireless form such as Bluetooth, Wi-Fi, RFID, or the like.

The term “abnormal current” as used in the following description means any form of current other than normal current supplied to the load, such as overcurrent or fault current. A circuit breaker 20 provided in a distribution board 10 according to an exemplary embodiment of the present disclosure may be configured to perform a breaking operation to break energization between a power supply source and a load when an abnormal current is detected.

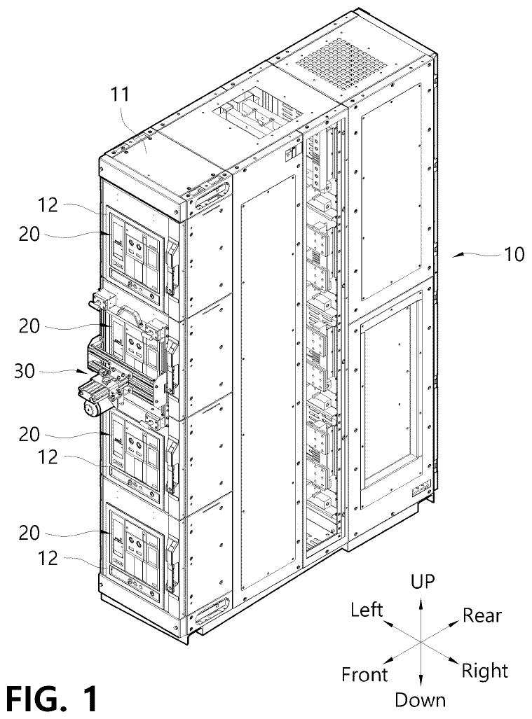

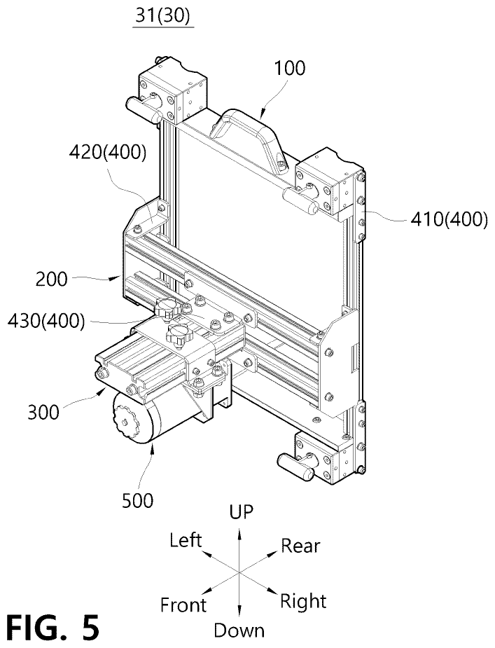

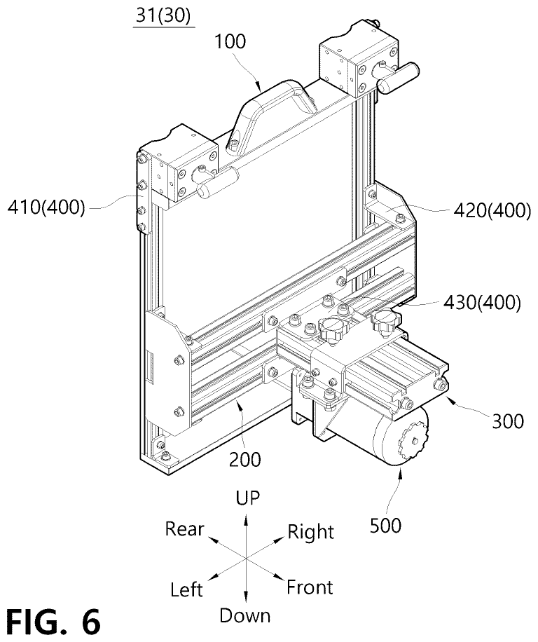

The terms “above or upper side”, “below or lower side”, “left side”, “right side”, “front side”, and “rear side” used in the following description will be understood with reference to the coordinate system shown in FIGS. 1, 5, and 6.

### 2. Description of the Distribution Board 10 and the Circuit Breaker 20 According to an Exemplary Embodiment of the Present Disclosure

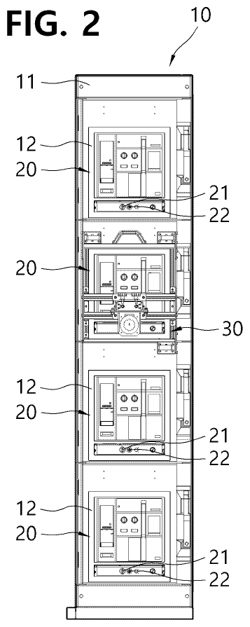

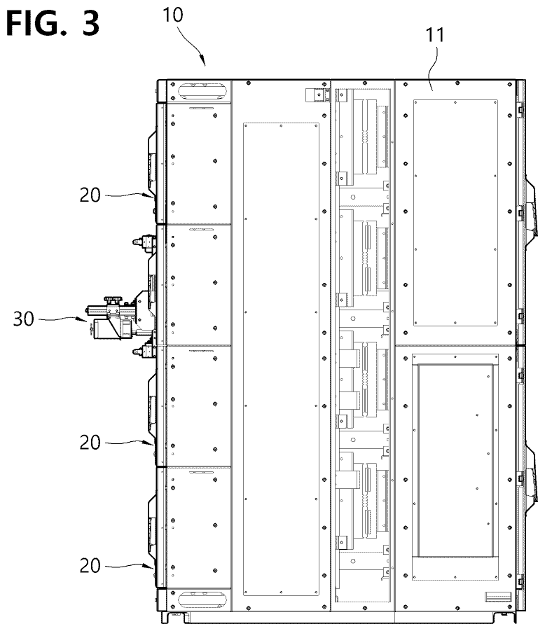

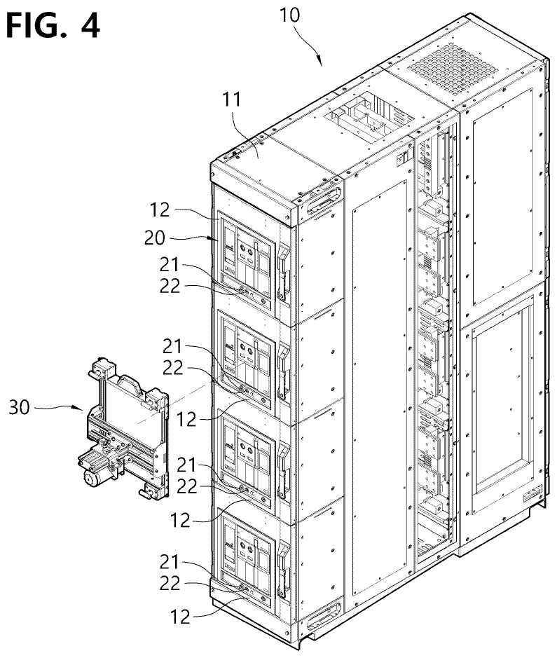

Referring to FIGS. 1 to 4, a distribution board 10 according to an exemplary embodiment of the present disclosure is shown. The distribution board 10 is energizably connected to an external power source (not shown) and an external load (not shown). Current or power transmitted from the external power source (not shown) can be transmitted to the external load (not shown) through the distribution board 10.

In this case, the circuit breaker 20 is withdrawably accommodated in the distribution board 10. The distribution board 10 and the circuit breaker 20 may be energizably connected to each other, and as a result, the circuit breaker 20 may be energizably connected to an external power source (not shown) and an external load (not shown), respectively. Therefore, current or power transmitted from the external power source (not shown) can be transmitted to the external load (not shown) after passing through the circuit breaker 20.

Therefore, when an abnormal current is detected, the circuit breaker 20 may perform a breaking operation to prevent damage to an external load (not shown) or a power accident.

The distribution board 10 may accommodate the circuit breaker 20 so as to be withdrawable and may be provided in an arbitrary shape that can be energized with an external power source (not shown) and an external load (not shown), respectively. In the illustrated embodiment, the distribution board 10 has a rectangular parallelepiped shape having a length in the front-rear direction, a width in the left-right direction, and a height in the up-down direction.

In the above embodiment, a plurality of distribution boards 10 may be provided and disposed in parallel in the width direction, that is, in the left-right direction in the illustrated embodiment, so that the amount of power to be energized may be increased.

In the illustrated embodiment, the distribution board 10 includes a distribution board housing 11 and an insertion space 12.

The distribution board housing 11 forms the outer shape of the distribution board 10. A space is formed inside the distribution board housing 11 so that various configurations for performing functions of the distribution board 10 may be mounted. In this case, the circuit breaker 20 may also be withdrawably accommodated in the space of the distribution board housing 11.

In the illustrated embodiment, an opening (reference numeral not indicated) that communicates with the space and functions as a passage through which the circuit breaker 20 is drawn in or out is formed on the front side of the distribution board housing 11. In the illustrated embodiment, the opening is formed to have a quadrangular cross-section corresponding to the shape of the circuit breaker 20.

The opening is surrounded by the insertion space 12.

The insertion space 12 is a portion where a draw in and out apparatus 30 according to an exemplary embodiment of the present disclosure is coupled to the distribution board 10. The draw in and out apparatus 30 is formed to surround the opening from the outside. In the illustrated embodiment, the draw in and out apparatus 30 has a quadrangular shape corresponding to the shape of the cross-section of the opening formed in a quadrangular shape.

The insertion space 12 may protrude from one side surface of the surfaces of the distribution board housing 11, from which the circuit breaker 20 is drawn in or out, that is, from the front side surface in the illustrated embodiment. Therefore, an operator can easily identify the insertion space 12 and couple the draw in and out apparatus 30 to the distribution board housing 11 to correspond to the location of the insertion space 12.

The circuit breaker 20 is withdrawably accommodated in the distribution board 10. In other words, the circuit breaker 20 may be drawn into the distribution board 10 and energizably connected with the components of the distribution board 10, an external power source (not shown), and an external load (not shown), respectively. In addition, the circuit breaker 20 may be drawn out from the distribution board 10 so that the energization state may be released.

The circuit breaker 20 may be drawn into the inner space of the distribution board housing 11 through the opening formed on the one side surface of the distribution board housing 11, that is, on the front side surface in the illustrated embodiment. To this end, the opening is formed to have a quadrangular cross-section corresponding to the shape of the circuit breaker 20, as described above.

When an abnormal current is detected, a process in which the circuit breaker 20 is operated to perform the breaking operation is a well-known technology, and thus a detailed description thereof will be omitted.

The circuit breaker 20 coupled to the distribution board housing 11 may be partially exposed outwardly. In addition, a portion of the circuit breaker 20 exposed to the outside may be disposed to be surrounded by the insertion space 12. In the illustrated embodiment, one surface of the front side of the circuit breaker 20 is exposed outwardly and is disposed to be surrounded by the insertion space 12.

A plurality of circuit breakers 20 may be provided. The plurality of circuit breakers 20 may be physically and electrically spaced apart from each other to be energizably connected with the components of the distribution board 10, an external power source (not shown), and an external load (not shown), respectively.

In the illustrated embodiment, four circuit breakers 20 are provided and disposed to be spaced apart from each other in the height direction of the distribution board 10, that is, in the up-down direction. The number and arrangement method of the circuit breakers 20 may be changed according to the magnitude of the electric current or electric power and the shape of the distribution board 10.

In the illustrated embodiment, the circuit breaker 20 includes a break button 21 and an apparatus insertion portion 22.

The break button 21 is a portion that is operated in advance so that the circuit breaker 20 can be drawn out. When the break button 21 is operated, the coupling state of the circuit breaker 20 and the distribution board 10 is released. In other words, as the break button 21 is operated, the circuit breaker 20 coupled to the distribution board 10 may be in a state that can be drawn out from the distribution board housing 11.

In addition, when the circuit breaker 20 is accommodated in the distribution board housing 11, the distribution board 10 and the circuit breaker 20 may be combined as the break button 21 is operated. In other words, as the break button 21 is operated, the circuit breaker 20 that was drawn in is not arbitrarily drawn out from the distribution board housing 11.

The break button 21 may be provided in an arbitrary form capable of forming or releasing a coupling state between the circuit breaker 20 and the distribution board 10. In the illustrated embodiment, the break button 21 is provided in the form of a button capable of performing the above operation by pressing the same. In the above embodiment, the break button 21 may be provided as a toggle button, and may be configured to form or release a coupling state between the circuit breaker 20 and the distribution board 10 according to the number of times of pressing.

As will be described later, before the draw in and out apparatus 30 according to an exemplary embodiment of the present disclosure is disposed in the insertion space 12, the break button 21 may be operated in advance. Alternatively, the break button 21 may be operated later after the draw in and out apparatus 30 is disposed in the insertion space 12. In either case, it is sufficient if the break button 21 can be pre-operated before the draw in and out apparatus 30 is operated.

The break button 21 is located at a lower side of one side surface where the circuit breaker 20 accommodated in the distribution board housing 11 is exposed to the outside, that is, the front side surface in the illustrated embodiment. The apparatus insertion portion 22 is disposed adjacent to the break button 21.

The apparatus insertion portion 22 is a portion to which a power unit 500 provided in the draw in and out apparatus 30 is coupled. A key 540 of the power unit 500 may be rotated while inserted into the apparatus insertion portion 22 to completely release the coupling state between the circuit breaker 20 and the distribution board housing 11.

The apparatus insertion portion 22 is located adjacent to the break button 21. In the illustrated embodiment, the apparatus insertion portion 22 is located at a lower side of the one side surface where the circuit breaker 20 accommodated in the distribution board housing 11 is exposed to the outside, that is, the front side surface.

The apparatus insertion portion 22 may be formed in a shape corresponding to the shape of the key 540. In this case, the apparatus insertion portion 22 may be formed to include at least one portion having an asymmetrical cross-section.

Therefore, the key 540 may be inserted into the apparatus insertion portion 22 only in a preset direction. Furthermore, when the inserted key 540 is rotated, the circuit breaker 20 may be drawn into the distribution board housing 11 drawn out from the distribution board housing 11 by rotation of a screw (not shown) or the like coupled to the apparatus insertion portion 22 by the asymmetric portion above.

### 3. Description of the Draw in and Out Apparatus 30 According to an Exemplary Embodiment of the Present Disclosure

Referring back to FIGS. 1 to 4, a draw in and out apparatus 30 according to an exemplary embodiment of the present disclosure is shown.

The draw in and out apparatus 30 according to an exemplary embodiment of the present disclosure may be coupled to the circuit breaker 20 to draw the circuit breaker 20 into the distribution board 10 or draw it out from the distribution board 10. In this case, the draw in and out apparatus 30 is equipped with a power unit 500, so that the draw in or out process of the circuit breaker 20 may be performed without operation by an operator.

Furthermore, the draw in and out apparatus 30 according to an exemplary embodiment of the present disclosure may be provided so that each component can be separated. In this case, each of the above components is movably coupled to each other so that the position at which the draw in and out apparatus 30 is coupled to the circuit breaker 20 may be varied. Furthermore, in the draw in and out apparatus 30, each component may be moved to a working position, assembled at the working position, and then coupled to the circuit breaker 20.

The draw in and out apparatus 30 is withdrawably coupled to the distribution board 10. The draw in and out apparatus 30 is coupled to one side of each side of the distribution board housing 11, in which the circuit breaker 20 is exposed to the outside, that is, the front side in the illustrated embodiment.

The draw in and out apparatus 30 is located adjacent to the insertion space 12. In the illustrated embodiment, the draw in and out apparatus 30 is coupled to the front side surface of the distribution board housing 11 so as to surround the insertion space 12 from the outside.

That is, the insertion space 12 is configured to guide the position where the draw in and out apparatus 30 is coupled to the one side surface of the distribution board housing 11, that is, the front side surface.

As will be described later, the draw in and out apparatus 30 may be coupled to the distribution board housing 11 by a magnetic force. To this end, the draw in and out apparatus 30 includes a magnet member 140, which will be described in detail later.

The draw in and out apparatus 30 covers the circuit breaker 20 exposed through the opening of the distribution board housing 11 and is coupled to the distribution board housing 11. In this case, as will be described later, an accommodation opening 130 is formed to be open inside the draw in and out apparatus 30. Therefore, it may be said that the draw in and out apparatus 30 is coupled to the distribution board housing 11 so that the accommodation opening 130 and the circuit breaker 20 overlap each other.

The draw in and out apparatus 30 is detachably coupled to the circuit breaker 20. The key 540 provided in the draw in and out apparatus 30 may be inserted into and coupled to the apparatus insertion portion 22 of the circuit breaker 20. When the motor member 510 of the power unit 500 is operated, the key 540 is rotated while inserted into the apparatus insertion portion 22, so that the circuit breaker 20 may be drawn into the distribution board housing 11 or drawn out from the distribution board housing 11.

The draw in and out apparatus 30 may be detachably coupled to the distribution board 10 and the circuit breaker 20, respectively, and may be provided in any form in which the circuit breaker 20 can be drawn into the distribution board housing 11 or drawn out from the distribution board housing 11.

A plurality of draw in and out apparatuses 30 may be provided. The plurality of draw in and out apparatuses 30 may be detachably respectively coupled to a plurality of circuit breakers 20 coupled to the distribution board 10. In this case, it will be understood that the plurality of draw in and out apparatuses 30 may be detachably coupled to the one side surface of the distribution board housing 11, that is, the front side surface in the illustrated embodiment.

The draw in and out apparatus 31 according to an exemplary embodiment of the present disclosure and the draw in and out apparatus 32 according to another exemplary embodiment of the present disclosure, which will be described below, have some differences in the structure of the configuration, but the coupling structure and function of the distribution board 10 and the circuit breaker 20 described above are the same. Accordingly, in the case of a common description in the following description, the draw in and out apparatuses 31 and 32 will be collectively referred to as the draw in and out apparatus 30.

### (1) Description of the Draw in and Out Apparatus 31 According to an Exemplary Embodiment of the Present Disclosure

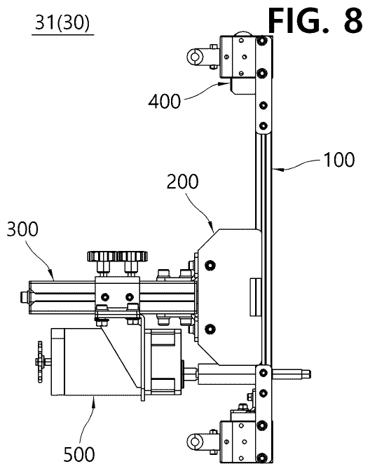

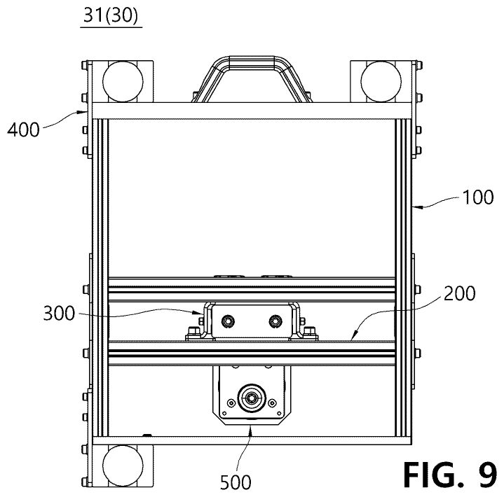

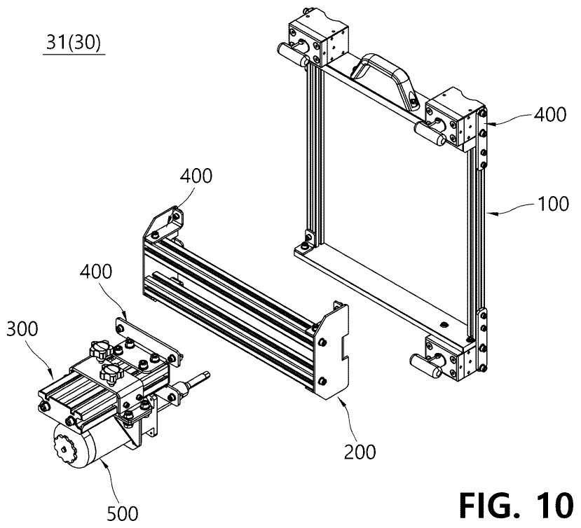

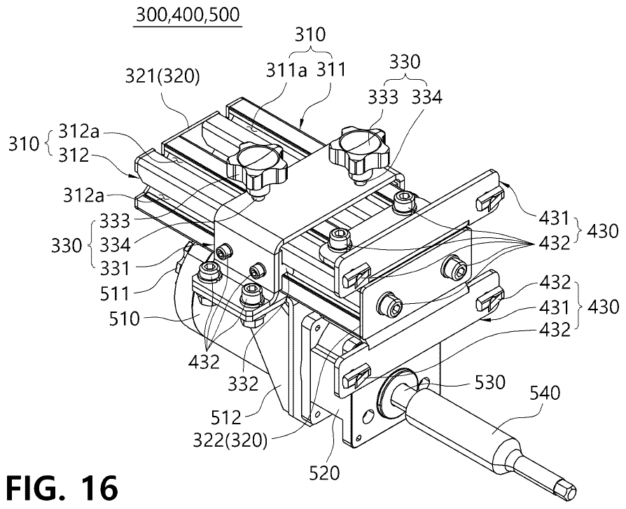

Referring to FIGS. 1 to 18, a draw in and out apparatus 31 according to an exemplary embodiment of the present disclosure is shown.

The draw in and out apparatus 31 according to an exemplary embodiment of the present disclosure may be detachably coupled to the distribution board 10. As will be described later, the coupling and removal of the draw in and out apparatus 31 and the distribution board 10 may be achieved by a magnetic force applied by the magnet member 140 provided in the draw in and out apparatus 31.

The draw in and out apparatus 31 according to an exemplary embodiment of the present disclosure may be detachably coupled to the circuit breaker 20. As will be described later, the coupling and removal of the draw in and out apparatus 31 and the circuit breaker 20 may be achieved by withdrawably inserting the key 540 into the apparatus insertion portion 22 of the circuit breaker 20.

Various components of the draw in and out apparatus 31 to be described later may be detachably coupled to each other. In particular, the power unit 500 formed by a high weight can be detachably provided, so that the movement and installation of the draw in and out apparatus 31 can be easily carried out.

The draw in and out apparatus 31 may be formed in a shape corresponding to the shape of the distribution board housing 11 and the circuit breaker 20 to be coupled thereto. In the illustrated embodiment, the distribution board housing 11 and the circuit breaker 20 are each formed to have a quadrangular cross-section, and the draw in and out apparatus 31 may also have a quadrangular cross-section in the vertical direction.

In the illustrated embodiment, the draw in and out apparatus 31 includes a first support unit 100, a second support unit 200, a third support unit 300, a coupling unit 400, and a power unit 500.

The first support unit 100 is a portion where the draw in and out apparatus 31 is coupled to the distribution board 10. The first support unit 100 is detachably coupled to the one side surface of the distribution board housing 11, that is, the front side surface in the illustrated embodiment.

The first support unit 100 forms a part of the outer shape of the draw in and out apparatus 31. The first support unit 100 is formed to have a size larger than that of other components of the draw in and out apparatus 31. Therefore, it may be said that the first support unit 100 functions as a frame of the draw in and out apparatus 31.

The first support unit 100 may be formed in an outer shape corresponding to the shape of the distribution board 10 or the circuit breaker 20. In the illustrated embodiment, the first support unit 100 is formed to have a quadrangular cross-section having a width in the left-right direction and a height in the up-down direction.

The first support unit 100 supports other components of the draw in and out apparatus 31. In the illustrated embodiment, the first support unit 100 movably supports the second support unit 200. As will be described later, the third support unit 300 and the power unit 500 are coupled to the second support unit 200. Therefore, it may be said that the first support unit 100 supports the second support unit 200, the third support unit 300, and the power unit 500.

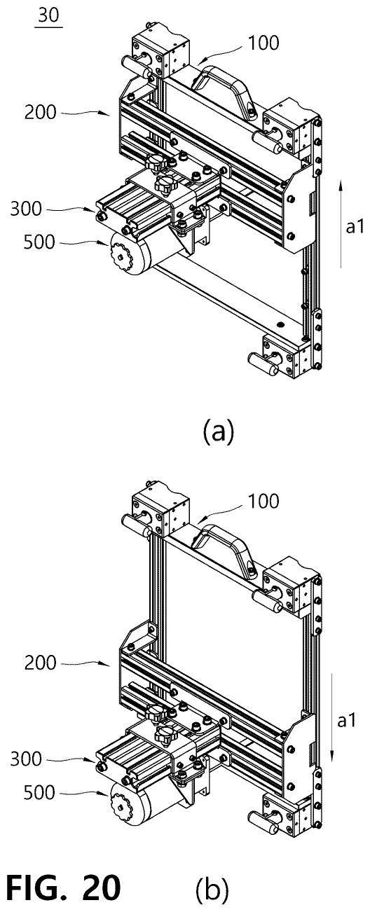

The first support unit 100 forms a path through which the other components of the draw in and out apparatus 31 move along the first axis a1 (see FIG. 20). In other words, the first support unit 100 is configured to guide the movement of other components of the draw in and out apparatus 31 along the first axis a1.

According to the above-described coupling relationship, it may be said that the first support unit 100 movably supports the second support unit 200, the third support unit 300, and the power unit 500 along the first axis a1.

The first support unit 100 is coupled to the coupling unit 400. Various components of the first support unit 100 may be fixedly coupled to each other by a first coupling unit 410. In addition, the first support unit 100 and the second support unit 200 may be movably coupled by a second coupling unit 420.

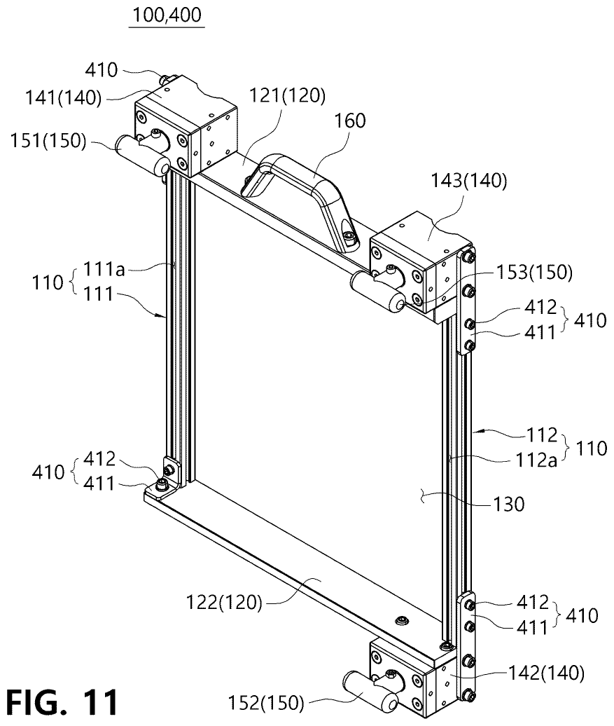

In the embodiment shown in FIG. 11, the first support unit 100 includes a column member 110, a plate member 120, an accommodation opening 130, a magnet member 140, a handle member 150, and a gripping member 160.

The column member 110 forms a part of the body of the first support unit 100. The column member 110 is formed to extend in one direction, that is, in the up-down direction in the illustrated embodiment, to form an outer shape in the width direction of the first support unit 100. As will be described later, the column member 110 functions as the first axis a1 for movably supporting the second support unit 200. Therefore, it may be said that the column member 110 extends along the first axis a1.

The column member 110 may be formed of a lightweight yet highly rigid material. This is to stably maintain the shape and coupling state of the draw in and out apparatus 31, and to movably and stably support the second support unit 200 and other components coupled to the second support unit 200.

The column member 110 may be formed of an electrically insulating material. In addition, the column member 110 may be formed of a material that is not magnetized by magnetic force. This is to prevent a situation in which the magnetic force for this is weakened or disturbed when the first support unit 100 is coupled to the distribution board housing 11 by the magnet member 140 to be described later.

In an embodiment, the column member 110 may be formed of aluminum (Al) or an alloy material including aluminum.

The column member 110 may be provided in any form capable of movably supporting the second support unit 200 and other components coupled thereto. In the illustrated embodiment, the column member 110 is provided with an aluminum profile having a quadrangular cross-section and extending in one direction. In the above embodiment, a hollow is formed inside the column member 110, so that the weight may be reduced and the rigidity may be reinforced.

The column member 110 is coupled to the plate member 120. The column member 110 is configured to support the plate member 120 in the longitudinal direction. In the illustrated embodiment, the column member 110 is coupled to ends in the left-right direction of the plate member 120.

In an embodiment in which a plurality of plate members 120 are provided, the column member 110 may be coupled to a plurality of plate members 120, respectively. In the illustrated embodiment, one end in the extension direction of the column member 110, that is, the upper end, is coupled to a first plate member 121 located on the upper side. The other end in the extension direction of the column member 110, that is, the lower end in the illustrated embodiment, is coupled to a second plate member 122 located on the lower side.

A plurality of column members 110 may be provided. The plurality of column members 110 may be disposed to be spaced apart from each other and coupled to different portions of the plate member 120, respectively. In addition, the plurality of column members 110 may movably support different portions of the second support unit 200.

In the illustrated embodiment, two column members 110 are provided, including a first column member 111 disposed on the left and coupled to the plate member 120 and the second support unit 200, respectively, and a second column member 112 disposed on the right and coupled to the plate member 120 and the second support unit 200, respectively. The first column member 111 and the second column member 112 are disposed to face each other with the accommodation opening 130 interposed therebetween, and surround the accommodation opening 130 in the width direction, that is, in the left-right direction in the illustrated embodiment.

The first column member 111 forms one side in the width direction of the first support unit 100, that is, the left side in the illustrated embodiment. The first column member 111 is formed to extend in the height direction of the first support unit 100, that is, in the up-down direction in the illustrated embodiment.

One end in the extension direction of the first column member 111, that is, the upper end in the illustrated embodiment, is fixedly coupled to the first plate member 121. The coupling may be achieved by the first coupling unit 410.

The other end in the extension direction of the first column member 111, that is, the lower end in the illustrated embodiment, is fixedly coupled to the second plate member 122. The coupling may also be achieved by the first coupling unit 410.

A first column hollow 111a is formed inside the first column member 111. The outer side of the first column hollow 111a is formed to be open and communicates with the outside. The second coupling unit 420 may be inserted into and coupled to the first column hollow 111a. Accordingly, the second support unit 200 may be coupled to the first column member 111 by the second coupling unit 420.

The first column hollow 111a is formed to extend in the extension direction of the first column member 111, that is, in the up-down direction in the illustrated embodiment, and each end of the extension direction, that is, the upper end and the lower end, is formed to be open. Therefore, the second coupling unit 420 accommodated in the first column hollow 111a and the second support unit 200 coupled thereto may be moved along the extension direction of the first column hollow 111a.

A plurality of first column hollows 111a may be provided. The plurality of first column hollows 111a may be formed on different side surfaces of the first column member 111, respectively. In the illustrated embodiment, four first column hollows 111a are formed on the front, rear, left and right side surfaces of the first column member 111, respectively.

The first column member 111 is disposed to face the second column member 112 with the accommodation opening 130 interposed therebetween.

The second column member 112 forms the other side in the width direction of the first support unit 100, that is, the right side in the illustrated embodiment. The second column member 112 is formed to extend in the height direction of the first support unit 100, that is, in the up-down direction in the illustrated embodiment.

One end in the extension direction of the second column member 112, that is, the upper end in the illustrated embodiment, is fixedly coupled to the first plate member 121. The coupling may be achieved by the first coupling unit 410.

The other end in the extension direction of the second column member 112, that is, the lower end in the illustrated embodiment, is fixedly coupled to the second plate member 122. The coupling may also be achieved by the first coupling unit 410.

A second column hollow 112a is formed inside the second column member 112. The outer side of the second column hollow 112a is formed to be open and communicates with the outside. The second coupling unit 420 may be inserted into and coupled to the second column hollow 112a. Accordingly, the second support unit 200 may be coupled to the second column member 112 by the second coupling unit 420.

The second column hollow 112a is formed to extend in the extension direction of the second column member 112, that is, in the up-down direction in the illustrated embodiment, and each end of the extension direction, that is, the upper end and the lower end, is formed to be open. Therefore, the second coupling unit 420 accommodated in the second column hollow 112a and the second support unit 200 coupled thereto may be moved along the extension direction of the second column hollow 112a.

A plurality of second column hollows 112a may be provided. The plurality of second column hollows 112a may be formed on different side surfaces of the second column member 112, respectively. In the illustrated embodiment, four second column hollows 112a are formed on the front, rear, left and right side surfaces of the second column member 112, respectively.

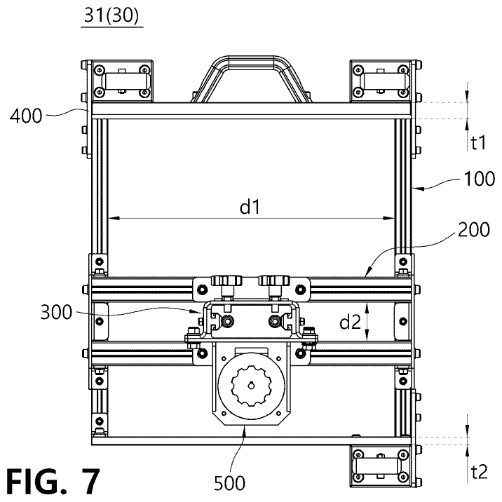

A distance at which the first column member 111 and the second column member 112 are spaced apart from each other may be defined as a first separation distance d1 (see FIG. 7). The first separation distance d1 may be defined as a length in the width direction of the plate member 120, that is, in the left-right direction in the illustrated embodiment.

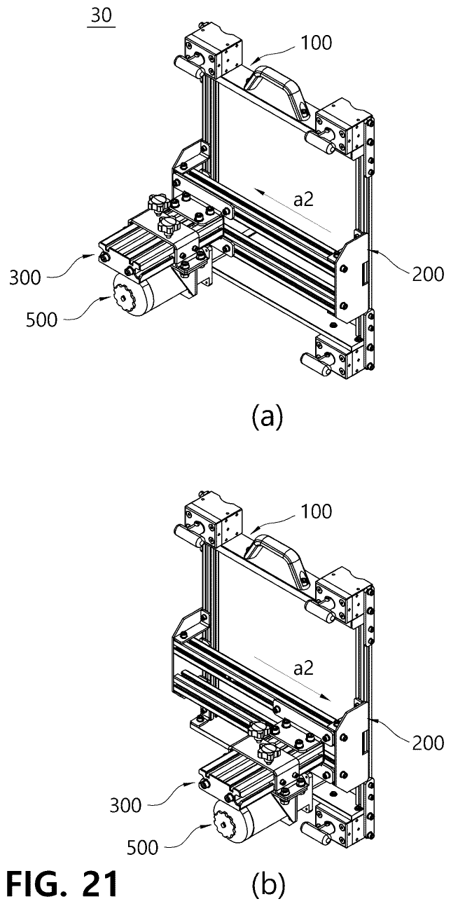

In addition, the first separation distance d1 may be defined as a distance by which the third support unit 300 and the power unit 500 coupled to the second support unit 200 can be moved along the width direction, that is, the second axis a2 (see FIG. 21).

In this case, the first separation distance d1 may be changed to correspond to the shape of the distribution board 10 or the circuit breaker 20. Therefore, the length in the width direction of the first support unit 100, that is, the length in a direction along the first axis a1 may be varied. As a result, the draw in and out apparatus 31 may actively correspond to the distribution board 10 or the circuit breaker 20 of various sizes.

The plate member 120 forms another part of the body of the first support unit 100. The plate member 120 is formed to extend in the other direction, that is, in the left-right direction in the illustrated embodiment, to form an outer shape in the height direction of the first support unit 100.

The plate member 120 may limit a movement distance in a direction along the first axis a1 of the second support unit 200. That is, the second support unit 200 coupled to the column member 110 may be moved along the first axis a1 until it contacts the plate member 120.

The plate member 120 may be formed of a lightweight yet highly rigid material. This is to stably maintain the shape of the first support unit 100 and the coupling state with the column member 110.

The plate member 120 may be formed of an electrically insulating material. In addition, the plate member 120 may be formed of a material that is not magnetized by magnetic force. This is to prevent a situation in which the magnetic force for this is weakened or disturbed when the first support unit 100 is coupled to the distribution board housing 11 by the magnet member 140.

In an embodiment, the plate member 120 may be formed of aluminum (Al) or an alloy material including aluminum.

As the name indicates, the plate member 120 may be provided in a plate shape. An end in the longitudinal direction of the plate member 120 may be fixedly coupled to the column member 110 by the first coupling unit 410.

The plate member 120 is coupled to the column member 110. The plate member 120 is configured to support the column member 110 in the longitudinal direction. In the illustrated embodiment, the plate member 120 is coupled to ends in the up-down direction of the column member 110.

In an embodiment in which a plurality of column members 110 are provided, the plate member 120 may be coupled to a plurality of column members 110, respectively. In the illustrated embodiment, one end in the extension direction of the plate member 120, that is, the left end, is coupled to the first column member 111 located on the left side. The other end in the extension direction of the plate member 120, that is, the right end, is coupled to the second column member 112 located on the right side.

A plurality of plate members 120 may be provided. The plurality of plate members 120 may be disposed to be spaced apart from each other and coupled to different portions of the column member 110, respectively. In addition, the plurality of plate members 120 may be disposed to face each other with the second support unit 200 interposed therebetween.

In the illustrated embodiment, two plate members 120 are provided, including a first plate member 121 disposed at the upper side and coupled to the column member 110 and a second plate member 122 disposed at the lower side and coupled to the column member 110. The first plate member 121 and the second plate member 122 are disposed to face each other with the accommodation opening 130 interposed therebetween, and surround the accommodation opening 130 in the height direction, that is, in the up-down direction in the illustrated embodiment.

The first plate member 121 forms one side in the height direction of the first support unit 100, that is, the upper side in the illustrated embodiment. The first plate member 121 is formed to extend in the width direction of the first support unit 100, that is, in the left-right direction in the illustrated embodiment.

One end in the extension direction of the first plate member 121, that is, the left end in the illustrated embodiment, is fixedly coupled to the first column member 111. The coupling may be achieved by the first coupling unit 410.

The other end in the extension direction of the first plate member 121, that is, the right end in the illustrated embodiment, is fixedly coupled to the second column member 112. The coupling may be achieved by the first coupling unit 410.

The first plate member 121 is coupled to the magnet member 140 and the gripping member 160 to support them. In an embodiment in which a plurality of magnet members 140 are provided, the first plate member 121 may support a first magnet member 141 and a third magnet member 143 positioned on the upper side.

The first plate member 121 may be formed to have a predetermined thickness, that is, a length in the up-down direction in the illustrated embodiment. The thickness of the first plate member 121 may be defined as a first thickness t1.

The first plate member 121 is disposed to face the second plate member 122 with the accommodation opening 130 interposed therebetween.

The second plate member 122 forms the other side in the height direction of the first support unit 100, that is, the lower side in the illustrated embodiment. The second plate member 122 is formed to extend in the width direction of the first support unit 100, that is, in the left-right direction in the illustrated embodiment.

One end in the extension direction of the second plate member 122, that is, the left end in the illustrated embodiment, is fixedly coupled to the first column member 111. The coupling may be achieved by the first coupling unit 410.

The other end in the extension direction of the second plate member 122, that is, the right end in the illustrated embodiment, is fixedly coupled to the second column member 112. The coupling may be achieved by the first coupling unit 410.

The second plate member 122 is coupled to the magnet member 140. In an embodiment in which a plurality of magnet members 140 are provided, the second plate member 122 may support a second magnet member 142 positioned on the lower side from the upper side. By the above arrangement, the accommodation opening 130 may be formed to have a quadrangular cross-section corresponding to the shape of the insertion space 12 or the circuit breaker 20.

The second plate member 122 may be formed to have a predetermined thickness, that is, a length in the up-down direction in the illustrated embodiment. The thickness of the second plate member 122 may be defined as a second thickness t2.

In this case, the first thickness t1 of the first plate member 121 may be greater than or equal to the second thickness t2 of the second plate member 122. This is because the first plate member 121 is configured to support a plurality of magnet members 140, and higher rigidity than the second plate member 122 is required.

This is also to ensure sufficient durability when an operator moves the first support unit 100 through the gripping member 160, as the first plate member 121 is coupled to the gripping member 160.

A space formed surrounded by the plurality of column members 110 and the plurality of plate members 120 may be defined as an accommodation opening 130.

The accommodation opening 130 is a space in which the circuit breaker 20 coupled to the draw in and out apparatus 31 is exposed to the outside. The accommodation opening 130 has one side opposite to the circuit breaker 20, i.e., the front side in the illustrated embodiment and the other side toward the circuit breaker 20, i.e., the rear side in the illustrated embodiment, respectively, formed to be open.

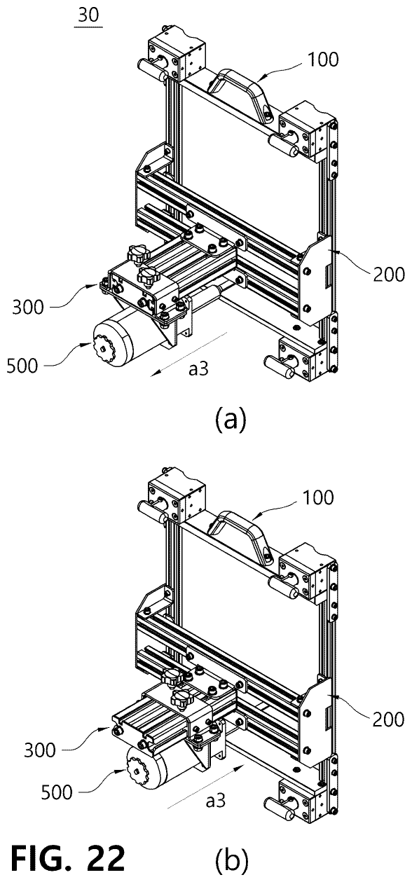

Accordingly, the third support unit 300 and the power unit 500 coupled to the second support unit 200 may be moved in a direction toward the circuit breaker 20 (i.e., the front side) or a direction opposite to the circuit breaker 20 (i.e., the rear side) along the third axis a3 (see FIG. 22).

The second support unit 200 is movably located in the accommodation opening 130. Accordingly, it will be understood that the third support unit 300 and the power unit 500 coupled to the second support unit 200 are also movably located in the accommodation opening 130. In the illustrated embodiment, the second support unit 200, the third support unit 300, and the power unit 500 are disposed to cover the accommodation opening 130 from the outside, that is, from the front side.

A distance by which the second support unit 200 located in the accommodation opening 130 may be moved along the first axis a1 may be limited by the first plate member 121 and the second plate member 122. That is, the second support unit 200 may be moved along the first axis a1 until it contacts the first plate member 121 or the second plate member 122.

A distance by which the third support unit 300 coupled to the second support unit 200 located in the accommodation opening 130 may be moved along the second axis a2 may be limited by the first column member 111 and the second column member 112. That is, the distance that the third support unit 300 coupled to the second support unit 200 is moved along the second axis a2 may be determined according to the first separation distance d1, which is a distance between the first column member 111 and the second column member 112.

The accommodation opening 130 may have any shape in which the second support unit 200, the third support unit 300 and the power unit 500 coupled thereto may be moved along any one or more of the first axis a1, the second axis a2, and the third axis a3. In the illustrated embodiment, the accommodation opening 130 is formed to have a quadrangular cross-section surrounded by the column member 110 in the left-right direction and by the plate member 120 in the up-down direction.

The magnet member 140 is a portion where the first support unit 100 is coupled to the distribution board housing 11. The magnet member 140 may be controlled to form or release a magnetic force by operating the handle member 150. The first support unit 100 and the distribution board housing 11 may be maintained in a coupled state by a magnetic force formed by the magnet member 140. That is, the first support unit 100 is detachably coupled to the distribution board housing 11 by a magnetic force.

It is preferable that the magnetic force formed by the magnet member 140 does not act on other components of the draw in and out apparatus 31. This is due to the possibility that the formed magnetic force is disturbed or weakened, and thus the coupling force between the magnet member 140 and the distribution board housing 11 is weakened.

Accordingly, as described above, the column member 110 and the plate member 120 positioned adjacent to the magnet member 140 may be formed of a material that is not magnetized, for example, a material such as aluminum. In addition, as will be described later, some or all of the components of the second support unit 200, the third support unit 300, the coupling unit 400, and the power unit 500 may also be formed of the above material.

Accordingly, the magnetic force formed by the magnet member 140 may not be transferred to other components and may be formed to be applied to the distribution board housing 11.

The magnet member 140 is coupled to the plate member 120. The magnet member 140 is supported by the plate member 120. In this case, the magnet member 140 may be disposed to face the accommodation opening 130 with the plate member 120 interposed therebetween. In other words, the magnet member 140 is disposed outside the accommodation opening 130.

Therefore, the second support unit 200 may be disposed in the accommodation opening 130 to be movable without being disturbed by the magnet member 140.

The magnet member 140 is coupled to the handle member 150. By operating the handle member 150, the magnet member 140 may be controlled to apply or release a magnetic force, that is, an attractive force, to the distribution board 10.

The magnet member 140 may be provided in any form that may be controlled to form or release a magnetic force by being adjusted by the handle member 150. Alternatively, the magnet member 140 may be provided in any form in which the intensity of the magnetic force formed by being adjusted by the handle member 150 may be controlled. In an embodiment, the magnet member 140 may be provided as an electromagnet, a permanent magnet, or the like.

A plurality of magnet members 140 may be provided. The plurality of magnet members 140 may be supported by the plate member 120 at different positions. Each of the plurality of magnet members 140 may be coupled to or separated from the distribution board 10.

In the illustrated embodiment, three magnet members 140 are provided, including a first magnet member 141, a second magnet member 142, and a third magnet member 143.

The first magnet member 141 is biased to the upper side and is coupled to and supported by the first plate member 121. The first magnet member 141 is located adjacent to one end in the extension direction of the first plate member 121, i.e., to the left end in the illustrated embodiment. In the above embodiment, it will be understood that the first magnet member 141 is located adjacent to the upper end of the first column member 111.

The second magnet member 142 is positioned to be biased to the lower side and is coupled to and supported by the second plate member 122. The second magnet member 142 is located adjacent to the other end in the extension direction of the second plate member 122, i.e., to the right end in the illustrated embodiment. In the above embodiment, it will be understood that the second magnet member 142 is located adjacent to the lower end of the second column member 112.

Therefore, it may be said that the first magnet member 141 and the second magnet member 142 are spaced apart from each other in a diagonal direction of the accommodation opening 130 to couple the first support unit 100 and the distribution board 10.

The third magnet member 143 is positioned to be biased to the upper side and is coupled to and supported by the first plate member 121. The third magnet member 143 is located adjacent to the other end in the extension direction of the first plate member 121, i.e., to the right end in the illustrated embodiment. In the above embodiment, it will be understood that the third magnet member 143 is located adjacent to the upper end of the second column member 112.

In this case, the third magnet member 143 may be optionally provided. In the illustrated embodiment, even if only the first magnet member 141 at the upper left side and the second magnet member 142 at the lower right side are provided, the first support unit 100 may be stably coupled to the distribution board 10.

However, in order to improve the coupling reliability by increasing the coupling force, it is preferable to include the third magnet member 143 to couple the first support unit 100 and the distribution board 10 at various positions.

Therefore, although not shown, it will be understood that an additional magnet member (not shown) may be provided on the lower left side of the second plate member 122. The handle member 150 is rotatably coupled to the magnet member 140.

The handle member 150 is configured to be rotatable by an external force. By operating the handle member 150, the magnet member 140 may be controlled to form or release a magnetic force. In another embodiment, the intensity of the magnetic force formed by the magnet member 140 may be controlled to be adjusted by operating the handle member 150.

The handle member 150 is rotatably coupled to the magnet member 140. In this case, it is preferable that the handle member 150 is positioned opposite to the distribution board 10 and is disposed to be exposed toward the outside of the distribution board 10. In the illustrated embodiment, the handle member 150 is positioned to be biased toward the front side and disposed to face the distribution board 10 with the magnet member 140 interposed therebetween.

The handle member 150 may be configured to be rotatable in the clockwise direction or counterclockwise direction.

When the handle member 150 is rotated in one direction of the clockwise direction and the counterclockwise direction, the magnet member 140 may be controlled to form a magnetic force or to increase the intensity of the formed magnetic force. When the handle member 150 is rotated in the other direction of the clockwise direction and the counterclockwise direction, the magnet member 140 may be controlled to release the magnetic force or to decrease the intensity of the formed magnetic force.

The handle member 150 may be provided in any form capable of controlling whether a magnetic force is formed or intensity of the magnet member 140 by being operated by an external force. In the illustrated embodiment, the handle member 150 is provided in the form of a dial that is operated by rotation. Alternatively, the handle member 150 may be provided in the form of a button that is operated by pressing.

A plurality of handle members 150 may be provided. The plurality of handle members 150 may be rotatably coupled to a plurality of magnet members 140, respectively. As the plurality of handle members 150 are operated, a magnetic force formed by the plurality of magnet members 140 may be controlled.

In this case, the plurality of handle members 150 may be rotated independently of each other. Accordingly, a magnetic force formed by the plurality of magnet members 140 to which the plurality of handle members 150 are coupled may also be controlled independently of each other.

In the illustrated embodiment, three handle members 150 are provided, including a first handle member 151, a second handle member 152, and a third handle member 153. The first handle member 151 is rotatably coupled to the first magnet member 141, the second handle member 152 to the second magnet member 142, and the third handle member 153 to the third magnet member 143, respectively.

The gripping member 160 is a portion where the first support unit 100 is gripped by an operator or any equipment.

The operator or any equipment may easily move the first support unit 100 and other components of the draw in and out apparatus 31 coupled to the first support unit 100 by gripping the gripping member 160. The gripping member 160 is positioned to be biased toward the upper side of the first support unit 100.

The gripping member 160 is coupled to the plate member 120. Specifically, the gripping member 160 is coupled to the outside of the first plate member 121 disposed on the upper side, i.e., the upper side in the illustrated embodiment. The gripping member 160 may be disposed at a central portion in the longitudinal direction of the first plate member 121, that is, at a central portion in the left-right direction in the illustrated embodiment.

The first thickness t1 of the first plate member 121 is formed to be greater than or equal to the second thickness t2, so that the coupling state between the gripping member 160 and the first plate member 121 may be stably maintained. In addition, as described above, the above structure allows the first support unit 100 to be moved while the gripping member 160 is gripped without deformation.

The gripping member 160 may have an arbitrary shape that can be gripped by an operator or equipment. In the illustrated embodiment, the gripping member 160 includes a first portion which obliquely extends from the upper surface of the first plate member 121, a second portion which is continuous with the first portion and extends horizontally, and a third portion which is continuous with the second portion and obliquely extends toward the upper surface of the first plate member 121.

The second support unit 200 is movably coupled to the first support unit 100. The second support unit 200 may be moved along the first axis a1 while being coupled to the first support unit 100. Accordingly, a position of the power unit 500 coupled to the second support unit 200 in a direction along the first axis a1, that is, a position in the up-down direction in the illustrated embodiment may be adjusted.

Therefore, it may be said that the second support unit 200 is coupled to the first support unit 100 so as to be elevated.

The second support unit 200 may be detachably coupled to the first support unit 100. The coupling is achieved by the second coupling unit 420.

The second support unit 200 supports other components of the draw in and out apparatus 31. In the illustrated embodiment, the second support unit 200 movably supports the third support unit 300 and the power unit 500.

The second support unit 200 forms a path through which the third support unit 300 and the power unit 500 coupled thereto move along the second axis a2 (see FIG. 21). In other words, the second support unit 200 is configured to guide the movement of the third support unit 300 and the power unit 500 along the second axis a2.

Therefore, it may be said that the second support unit 200 movably supports the third support unit 300 and the power unit 500 along the second axis a2.

The second support unit 200 is coupled to the coupling unit 400. Various components of the second support unit 200 may be fixedly coupled to each other by the second coupling unit 420. In addition, the second support unit 200 may be movably coupled to the first support unit 100 by the second coupling unit 420. Furthermore, the third support unit 300 and the power unit 500 coupled thereto may be movably coupled to the second support unit 200 by a third coupling unit 430.

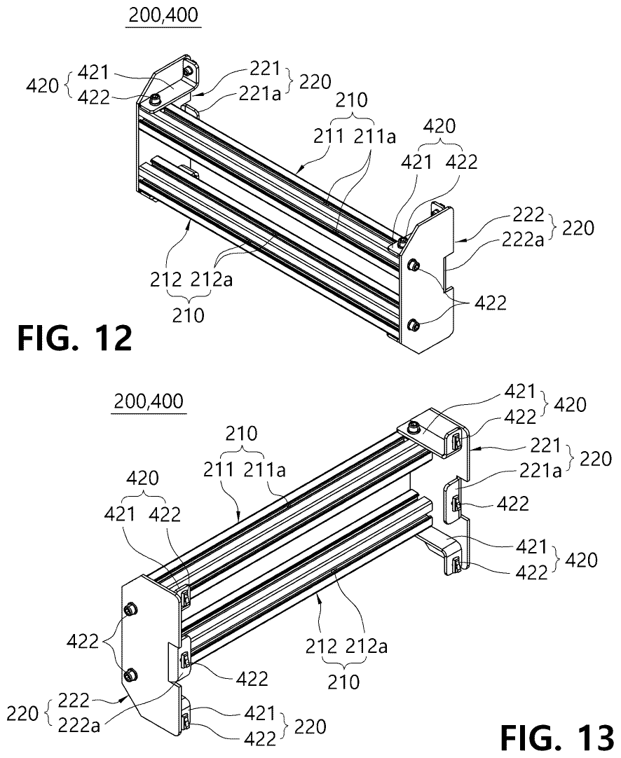

In the embodiments shown in FIGS. 12 to 14, the second support unit 200 includes a beam member 210 and a partition wall member 220.

The beam member 210 forms a part of the second support unit 200. The beam member 210 is formed to extend in one direction, that is, in the left-right direction in the illustrated embodiment, to form an outer shape in the height direction of the second support unit 200. As will be described later, the beam member 210 functions as the second axis a2 for movably supporting the third support unit 300 and the power unit 500. Therefore, it may be said that the beam member 210 extends along the second axis a2.

The beam member 210 may be formed of a lightweight yet highly rigid material. This is to stably maintain the shape and coupling state of the draw in and out apparatus 31, and to movably and stably support the first support unit 100, the third support unit 300 and the power unit 500 coupled thereto.

The beam member 210 may be formed of an electrically insulating material. In addition, the beam member 210 may be formed of a material that is not magnetized by magnetic force. This is to prevent a situation in which the magnetic force formed by the magnet member 140 for coupling the first support unit 100 and the distribution board housing 11 is weakened or disturbed.

In an embodiment, the beam member 210 may be formed of aluminum or an alloy material including aluminum.

The beam member 210 may be provided in any form capable of movably supporting the third support unit 300 and the power unit 500. In the illustrated embodiment, the beam member 210 is provided with an aluminum profile having a quadrangular cross-section and extending in one direction. In the above embodiment, a hollow is formed inside the beam member 210 to be lightweight and high rigidity.

The beam member 210 is coupled to the partition wall member 220. The beam member 210 is configured to support the partition wall member 220 in the width direction. In the illustrated embodiment, the beam member 210 is coupled to the inner surface of the partition wall member 220.

In an embodiment in which a plurality of partition wall members 220 are provided, the beam member 210 may be coupled to a plurality of partition wall members 220, respectively. In the illustrated embodiment, one end in the extension direction of the beam member 210, that is, the left end, is coupled to the inner surface (i.e., the right side surface) of a first partition wall member 221 located on the left side. In the illustrated embodiment, the other end in the extension direction of the beam member 210, that is, the right end, is coupled to the inner surface (i.e., the left side surface) of a second partition wall member 222 located on the right side.

A plurality of beam members 210 may be provided. The plurality of beam members 210 may be disposed to be spaced apart from each other and coupled to different portions of the partition wall member 220, respectively. In addition, the plurality of beam members 210 may movably support different portions of the third support unit 300.

In the illustrated embodiment, two beam members 210 are provided, including a first beam member 211 disposed on the upper side and coupled to the partition wall member 220 and the third support unit 300, respectively, and a second beam member 212 disposed on the lower side and coupled to the partition wall member 220 and the third support unit 300, respectively.

The first beam member 211 forms one side in the height direction of the second support unit 200, that is, the upper side in the illustrated embodiment. The first beam member 211 is formed to extend in the width direction of the second support unit 200, that is, in the left-right direction in the illustrated embodiment.

One end in the extension direction of the first beam member 211, that is, the left end in the illustrated embodiment, is fixedly coupled to the first partition wall member 221. The coupling may be achieved by the second coupling unit 420.

The other end in the extension direction of the first beam member 211, that is, the right end in the illustrated embodiment, is fixedly coupled to the second partition wall member 222. The coupling may also be achieved by the second coupling unit 420.

A first beam hollow 211a is formed inside the first beam member 211. The outer side of the first beam hollow 211a is formed to be open and communicates with the outside. The third coupling unit 430 may be inserted into and coupled to the first beam hollow 211a. Accordingly, the third support unit 300 may be coupled to the first beam member 211 by the third coupling unit 430.

The first beam hollow 211a is formed to extend in the extension direction of the first beam member 211, that is, in the left-right direction in the illustrated embodiment, and each end of the extension direction, that is, the left end and the right end, is formed to be open. Therefore, the third coupling unit 430 accommodated in the first beam hollow 211a and the third support unit 300 coupled thereto may be moved along the extension direction of the first beam hollow 211a.

A plurality of first beam hollows 211a may be provided. The plurality of first beam hollows 211a may be formed on different side surfaces of the first beam member 211, respectively. In the illustrated embodiment, four first beam hollows 211a are formed on the front, rear, upper and lower surfaces of the first beam member 211, respectively.

The second beam member 212 forms the other side in the height direction of the second support unit 200, that is, the lower side in the illustrated embodiment. The second beam member 212 is formed to extend in the width direction of the second support unit 200, that is, in the left-right direction in the illustrated embodiment.

One end in the extension direction of the second beam member 212, that is, the left end in the illustrated embodiment, is fixedly coupled to the first partition wall member 221. The coupling may be achieved by the second coupling unit 420.

The other end in the extension direction of the second beam member 212, that is, the right end in the illustrated embodiment, is fixedly coupled to the second partition wall member 222. The coupling may also be achieved by the second coupling unit 420.

A second beam hollow 212a is formed inside the second beam member 212. The outer side of the second beam hollow 212a is formed to be open and communicates with the outside. The third coupling unit 430 may be inserted into and coupled to the second beam hollow 212a. Accordingly, the third support unit 300 may be coupled to the second beam member 212 by the third coupling unit 430.

The second beam hollow 212a is formed to extend in the extension direction of the second beam member 212, that is, in the left-right direction in the illustrated embodiment, and each end of the extension direction, that is, the left end and the right end, is formed to be open. Therefore, the third coupling unit 430 accommodated in the second beam hollow 212a and the third support unit 300 coupled thereto may be moved along the extension direction of the second beam hollow 212a.

A plurality of second beam hollows 212a may be formed. The plurality of second beam hollows 212a may be formed on different side surfaces of the second beam member 212, respectively. In the illustrated embodiment, four second beam hollows 212a are formed on the front, rear, upper and lower surfaces of the second beam member 212, respectively.

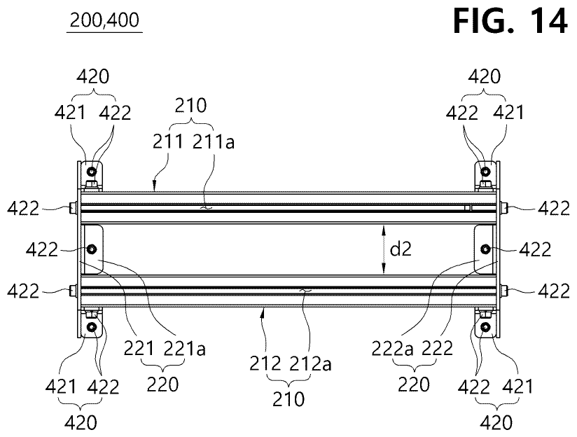

A distance at which the first beam member 211 and the second beam member 212 are spaced apart from each other may be defined as a second separation distance d2 (see FIGS. 13 and 14). The second separation distance d2 may be defined as a distance in which each portion in which the third support unit 300 and the power unit 500 are coupled to the second support unit 200 is spaced apart in the up-down direction.

In this case, the second separation distance d2 may be changed to correspond to the shape of the distribution board 10 or the circuit breaker 20. The second separation distance d2 may be changed to correspond to the shape of the third support unit 300 or the power unit 500 coupled to the second support unit 200. As a result, the draw in and out apparatus 31 may be structurally changed according to the installation environment, corresponding to the distribution board 10, the circuit breaker 20 or other components of the draw in and out apparatus 31 of various sizes.

The partition wall member 220 forms another part of the second support unit 200. The partition wall member 220 is formed to extend in the other direction, that is, in the up-down direction and the front-rear direction in the illustrated embodiment, to form an outer shape in the width direction of the second support unit 200.

The partition wall member 220 may limit a movement distance in a direction along the second axis a2 of the third support unit 300. That is, the third support unit 300 coupled to the beam member 210 may be moved along the second axis a2 until it contacts the partition wall member 220.

The partition wall member 220 may be formed of a lightweight yet highly rigid material. This is to stably maintain the shape of the second support unit 200 and the coupling state with the beam member 210.

The partition wall member 220 may be formed of an electrically insulating material. In addition, the partition wall member 220 may be formed of a material that is not magnetized by magnetic force. This is to prevent a situation in which the magnetic force formed by the magnet member 140 for the coupling of the first support unit 100 and the distribution board housing 11 is weakened or disturbed.

In an embodiment, the partition wall member 220 may be formed of aluminum or an alloy material including aluminum.

The partition wall member 220 may be provided in a plate shape. An inner surface of the partition wall member 220 may be fixedly coupled to the beam member 210 by the second coupling unit 420. In addition, an end in the longitudinal direction of the partition wall member 220, that is, the rear end in the illustrated embodiment, may be movably coupled to the column member 110 by the second coupling unit 420.

The partition wall member 220 is coupled to the beam member 210. The partition wall member 220 is configured to support the beam member 210 in the longitudinal direction. In the illustrated embodiment, the partition wall member 220 is coupled to ends in the left-right direction of the beam member 210.

A plurality of partition wall members 220 may be provided. The plurality of partition wall members 220 may be disposed to be spaced apart from each other and coupled to different portions of the beam member 210, respectively. In addition, the plurality of partition wall members 220 may be disposed to face each other with the beam member 210 interposed therebetween.

In the illustrated embodiment, two partition wall members 220 are provided, including a first partition wall member 221 disposed on the left side and coupled to the left end of the beam member 210 and a second partition wall member 222 disposed on the right side and coupled to the right end of the beam member 210. The first partition wall member 221 and the second partition wall member 222 are arranged to face each other with the beam member 210 interposed therebetween.

The first partition wall member 221 forms one side in the width direction of the second support unit 200, that is, the left side in the illustrated embodiment. The first partition wall member 221 is formed to extend in a direction different from that of the beam member 210, that is, in the front-rear direction and the up-down direction in the illustrated embodiment.

One end in the extension direction of the first partition wall member 221, that is, the rear end in the illustrated embodiment, is movably coupled to the first column member 111. The coupling may be achieved by the second coupling unit 420.

An inner surface of the first partition wall member 221, that is, the right side surface in the illustrated embodiment, is fixedly coupled to the left end of the beam member 210. The coupling may also be achieved by the second coupling unit 420.

A first bent portion 221a is formed at one edge of the portion of the first partition wall member 221 toward the first column member 111, that is, at the rear edge in the illustrated embodiment.

The first bent portion 221a is formed by bending inward at a predetermined angle with the first partition wall member 221. In the illustrated embodiment, the first bent portion 221a is formed to be bent to the right perpendicular to the first partition wall member 221.

The first bent portion 221a is movably coupled to the first column member 111 by the second coupling unit 420. As will be described later, the first bent portion 221a forms an intermediate part among a plurality of points at which the second support unit 200 is coupled to the first column member 111.

Therefore, by the first bent portion 221a, the number of points at which the second support unit 200 and the first column member 111 are coupled is increased, so that the second support unit 200 and the first support unit 100 may be stably coupled.

The second partition wall member 222 forms the other side in the width direction of the second support unit 200, that is, the right side in the illustrated embodiment. The second partition wall member 222 is formed to extend in a direction different from that of the beam member 210, that is, in the front-rear direction and the up-down direction in the illustrated embodiment.

One end in the extension direction of the second partition wall member 222, that is, the rear end in the illustrated embodiment, is movably coupled to the second column member 112. The coupling may be achieved by the second coupling unit 420.

An inner surface of the second partition wall member 222, that is, the left side surface in the illustrated embodiment, is fixedly coupled to the right end of the beam member 210. The coupling may also be achieved by the second coupling unit 420.

A second bent portion 222a is formed at one edge of the portion of the second partition wall member 222 toward the second column member 112, that is, at the rear edge in the illustrated embodiment.

The second bent portion 222a is formed by bending inward at a predetermined angle with the second partition wall member 222. In the illustrated embodiment, the second bent portion 222a is formed to be bent to the left perpendicular to the second partition wall member 222.

The second bent portion 222a is movably coupled to the second column member 112 by the second coupling unit 420. As will be described later, the second bent portion 222a forms an intermediate part among a plurality of points at which the second support unit 200 is coupled to the second column member 112.

Therefore, by the second bent portion 222a, the number of points at which the second support unit 200 and the second column member 112 are coupled is increased, so that the second support unit 200 and the first support unit 100 may be stably coupled.

The third support unit 300 is coupled to the second support unit 200. The third support unit 300 may be moved along the first axis a1 together with the second support unit 200. Accordingly, a position of the third support unit 300 and the power unit 500 coupled thereto in a direction along the first axis a1, that is, a position in the up-down direction in the illustrated embodiment may be adjusted.

The third support unit 300 is movably coupled to the second support unit 200. The third support unit 300 may be moved along the second axis a2 while being coupled to the second support unit 200. Accordingly, a position of the third support unit 300 and the power unit 500 coupled thereto in a direction along the second axis a2, that is, a position in the left-right direction in the illustrated embodiment may be adjusted.

The power unit 500 is movably coupled to the third support unit 300. The power unit 500 may be moved along the third axis a3 while being coupled to the third support unit 300 (see FIG. 22). Accordingly, the position of the power unit 500 along the third axis a3, that is, the position in the front-rear direction in the illustrated embodiment may be adjusted.

The third support unit 300 may be detachably coupled to the second support unit 200. The coupling is achieved by the third coupling unit 430.

The third support unit 300 may be detachably coupled to the power unit 500. The coupling is also achieved by the third coupling unit 430.

The third support unit 300 is coupled to the coupling unit 400. Each component of the third support unit 300 may be coupled to each other by the third coupling unit 430, or may be coupled to the second support unit 200 or the power unit 500.

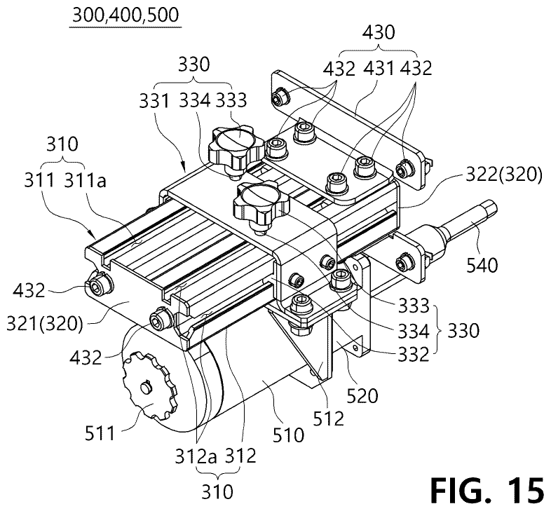

In the embodiments shown in FIGS. 15 to 18, the third support unit 300 includes a bar member 310, a support member 320, and an adjustment member 330.

The bar member 310 forms a part of the third support unit 300. The bar member 310 is formed to extend in one direction, that is, in the front-rear direction in the illustrated embodiment, to form an outer shape in the longitudinal direction of the third support unit 300. As will be described later, the bar member 310 functions as the third axis a3 for movably supporting the power unit 500. Therefore, it may be said that the bar member 310 extends along the third axis a3.

The bar member 310 may be formed of a lightweight yet highly rigid material. This is to stably maintain the shape and coupling state of the draw in and out apparatus 31, and to be movably coupled to the second support unit 200 and the power unit 500, respectively.

The bar member 310 may be formed of an electrically insulating material. In addition, the bar member 310 may be formed of a material that is not magnetized by magnetic force. This is to prevent a situation in which the magnetic force formed by the magnet member 140 for coupling the first support unit 100 and the distribution board housing 11 is weakened or disturbed.

In an embodiment, the beam member 210 may be formed of aluminum or an alloy material including aluminum.

The bar member 310 may be provided in any form capable of movably supporting the power unit 500. In the illustrated embodiment, the bar member 310 is provided with an aluminum profile having a quadrangular cross-section and extending in one direction. In the above embodiment, a hollow is formed inside the bar member 310 to be lightweight and high rigidity

The bar member 310 is coupled to the support member 320. Each end in the extension direction of the bar member 310 may be supported by the support member 320. In an embodiment in which a plurality of bar members 310 are provided, the plurality of bar members 310 may be coupled to and supported by the support member 320, respectively.

In an embodiment in which a plurality of support members 320 are provided, each end in the extension direction of the bar member 310 may be coupled to and supported by the plurality of support members 320, respectively. In the illustrated embodiment, the front end of the bar member 310 is coupled to and supported by a first support member 321. The rear end of the bar member 310 is coupled to and supported by a second support member 322.

The bar member 310 is coupled to the adjustment member 330. Specifically, the bar member 310 movably supports the adjustment member 330. While the adjustment member 330 is coupled to the bar member 310, the adjustment member 330 may extend in the extension direction of the bar member 310, that is, in the front-rear direction in the illustrated embodiment.

As described above, the above direction may be defined as a direction along the third axis a3. Therefore, it may be said that the bar member 310 movably supports the adjustment member 330 in a direction along the third axis a3.

A plurality of bar members 310 may be provided. The plurality of bar members 310 may be disposed to be spaced apart from each other and coupled to the support member 320 at different positions. In addition, the plurality of bar members 310 may movably support the adjustment member 330 at different positions.

In the illustrated embodiment, two bar members 310 are provided, including a first bar member 311 that is disposed to be biased to the left and coupled to the left side of the support member 320 and the left side of the adjustment member 330, and a second bar member 312 that is disposed to be biased to the right and coupled to the right side of the support member 320 and the right side of the adjustment member 330, respectively.

The first bar member 311 forms one side in the width direction of the third support unit 300, that is, the left side in the illustrated embodiment. The first bar member 311 is formed to extend in the longitudinal direction of the third support unit 300, that is, in the front-rear direction in the illustrated embodiment.

One end in the extension direction of the first bar member 311, that is, the front end in the illustrated embodiment, is fixedly coupled to the first support member 321. The other end in the extension direction of the first bar member 311, that is, the rear end in the illustrated embodiment, is fixedly coupled to the second support member 322. The couplings may be achieved by the third coupling unit 430.

A first bar hollow 311a is formed inside the first bar member 311. The outer side of the first bar hollow 311a is formed to be open and communicates with the outside. An adjustment extension 334 of the adjustment member 330 and the third coupling unit 430 may be inserted into and coupled to the first bar hollow 311a. Accordingly, the first bar member 311 may be coupled to the beam member 210, the adjustment member 330, and the power unit 500.

The first bar hollow 311a is formed to extend in the extension direction of the first bar member 311, that is, in the front-rear direction in the illustrated embodiment, and each end of the extension direction, that is, the front end and the rear end, is formed to be open. Therefore, the adjustment extension 334 and the third coupling unit 430 accommodated in the first bar hollow 311a may be moved along the extension direction of the first bar hollow 311a.

A plurality of first bar hollows 311a may be provided. The plurality of first bar hollows 311a may be formed on different side surfaces of the first bar member 311, respectively. In the illustrated embodiment, four first bar hollows 311a are formed on the upper, lower, left and right side surfaces of the first bar member 311, respectively.

The second bar member 312 forms the other side in the width direction of the third support unit 300, that is, the right side in the illustrated embodiment. The second bar member 312 is formed to extend in the longitudinal direction of the third support unit 300, that is, in the front-rear direction in the illustrated embodiment.

One end in the extension direction of the second bar member 312, that is, the front end in the illustrated embodiment, is fixedly coupled to the first support member 321. The other end in the extension direction of the second bar member 312, that is, the rear end in the illustrated embodiment, is fixedly coupled to the second support member 322. The couplings may be achieved by the third coupling unit 430.

A second bar hollow 312a is formed inside the second bar member 312. The outer side of the second bar hollow 312a is formed to be open and communicates with the outside. The adjustment extension 334 of the adjustment member 330 and the third coupling unit 430 may be inserted into and coupled to the second bar hollow 312a. Accordingly, the second bar member 312 may be coupled to the beam member 210, the adjustment member 330, and the power unit 500.

The second bar hollow 312a is formed to extend in the extension direction of the second bar member 312, that is, in the front-rear direction in the illustrated embodiment, and each end of the extension direction, that is, the front end and the rear end, is formed to be open. Therefore, the adjustment extension 334 and the third coupling unit 430 accommodated in the second bar hollow 312a may be moved along the extension direction of the second bar hollow 312a.

A plurality of second bar hollows 312a may be provided. The plurality of second bar hollows 312a may be formed on different side surfaces of the second bar member 312, respectively. In the illustrated embodiment, four second bar hollows 312a are formed on the upper, lower, left and right side surfaces of the second bar member 312, respectively.

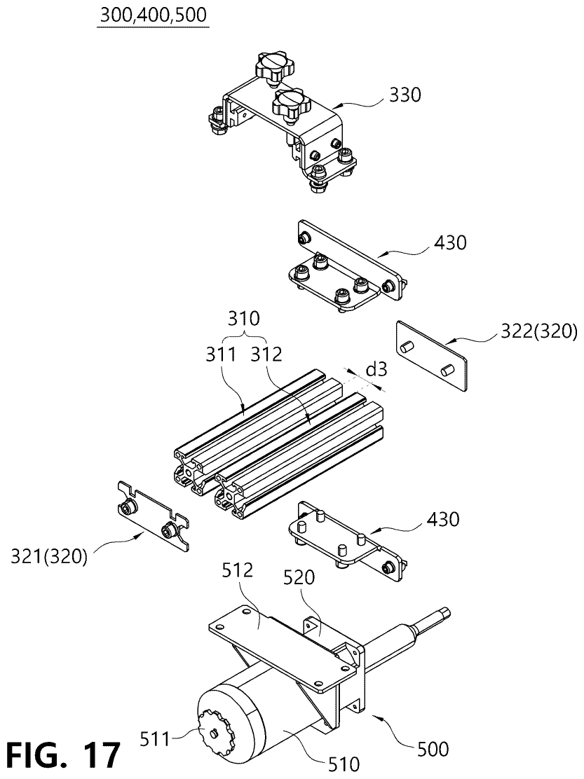

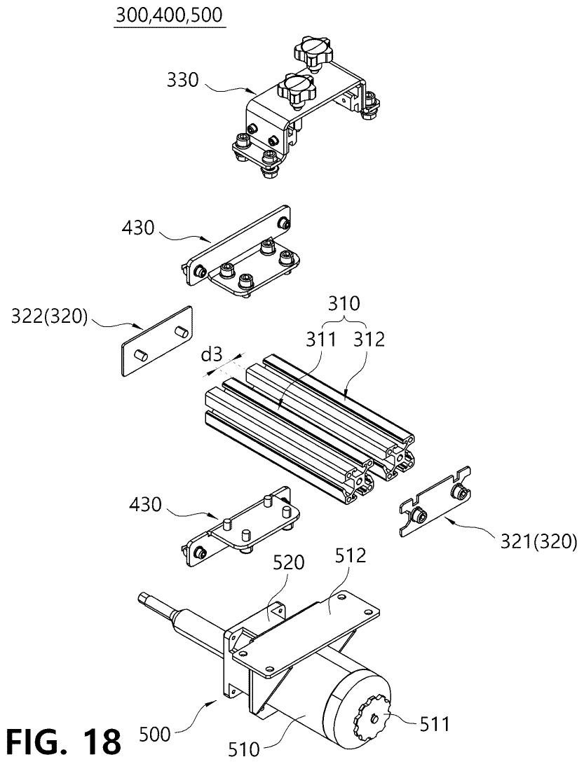

A distance at which the first bar member 311 and the second bar member 312 are spaced apart from each other may be defined as a third separation distance d3 (see FIGS. 17 and 18). The third separation distance d3 may be defined as a distance in which each portion in which the support member 320, the adjustment member 330 or the power unit 500 is coupled to the bar member 310 is spaced apart in the left-right direction.

In this case, the third separation distance d3 may be changed to correspond to the shape of the distribution board 10 or the circuit breaker 20. The third separation distance d3 may be changed to correspond to the shape of the support member 320, the adjustment member 330 or the power unit 500 coupled to the bar member 310.

As a result, the draw in and out apparatus 31 may be structurally changed according to the installation environment, corresponding to the distribution board 10, the circuit breaker 20 or other components of the draw in and out apparatus 31 of various sizes.

The support member 320 forms another part of the third support unit 300. The support member 320 is formed to extend in the other direction, that is, in the left-right direction and the up-down direction in the illustrated embodiment, to form an outer shape in the longitudinal direction of the third support unit 300.

The support member 320 is coupled to the bar member 310 to support the bar member 310. In an embodiment in which a plurality of bar members 310 are provided, the support member 320 is coupled to each of the plurality of bar members 310 to support them, and at the same time maintains the distance between the plurality of bar members 310, that is, the third separation distance d3.

The support member 320 may be formed of a lightweight yet highly rigid material. This is to stably maintain the shape of the third support unit 300 and the coupling state with the bar member 310.

The support member 320 may be formed of an electrically insulating material. In addition, the support member 320 may be formed of a material that is not magnetized by magnetic force. This is to prevent a situation in which the magnetic force formed by the magnet member 140 for the coupling of the first support unit 100 and the distribution board housing 11 is weakened or disturbed.

In an embodiment, the support member 320 may be formed of aluminum or an alloy material including aluminum.

The support member 320 may be provided in a plate shape. The support member 320 may be fixedly coupled to the bar member 310 by the third coupling unit 430.

The support member 320 is coupled to the bar member 310. The support member 320 is configured to support the bar member 310 in the longitudinal direction. In the illustrated embodiment, the support member 320 is coupled to ends in the front-rear direction of the bar member 310.

The shape of the cross-section of the support member 320 may be formed corresponding to the shape of the cross-section of the bar member 310. That is, in the illustrated embodiment, grooves corresponding to the first and second bar hollows 311a and 312a may be formed at outer edges of the support member 320.

A plurality of support members 320 may be provided. The plurality of support members 320 may be disposed to be spaced apart from each other and coupled to different portions of the bar member 310, respectively. In addition, the plurality of support members 320 may be disposed to face each other with the bar member 310 interposed therebetween.

In the illustrated embodiment, two support members 320 are provided, including a first support member 321 disposed on the front side and coupled to the front end of the bar member 310 and a second support member 322 disposed on the rear side and coupled to the rear end of the bar member 310. The first support member 321 and the second support member 322 are arranged to face each other with the bar member 310 interposed therebetween.

The first support member 321 forms one side in the longitudinal direction of the third support unit 300, that is, the front side in the illustrated embodiment. The first support member 321 is formed to extend in a direction different from that of the bar member 310, that is, in the left-right direction and the up-down direction in the illustrated embodiment.

The first support member 321 may be configured to be coupled to a plurality of bar members 310. In the illustrated embodiment, the first support member 321 may be coupled to the front end of the first bar member 311 and the front end of the second bar member 312, respectively. The coupling may be achieved by the third coupling unit 430.

The first support member 321 is disposed to face the second support member 322 with the bar member 310 interposed therebetween.

The second support member 322 forms the other side in the longitudinal direction of the third support unit 300, that is, the rear side in the illustrated embodiment. The second support member 322 is formed to extend in a direction different from that of the bar member 310, that is, in the left-right direction and the up-down direction in the illustrated embodiment.

The second support member 322 may be configured to be coupled to a plurality of bar members 310. In the illustrated embodiment, the second support member 322 may be coupled to the rear end of the first bar member 311 and the rear end of the second bar member 312, respectively. The coupling may be achieved by the third coupling unit 430.

The adjustment member 330 is coupled to the power unit 500 and moved together with the power unit 500. The adjustment member 330 may be moved in the extension direction of the bar member 310, that is, in the front-rear direction in the illustrated embodiment. In other words, the adjustment member 330 may be moved in a direction along the third axis a3.

The adjustment member 330 is movably coupled to the bar member 310. In the illustrated embodiment, an adjustment guide 332 and the adjustment extension 334 provided on the adjustment member 330 are movably coupled to the first and second bar hollows 311a and 312a, respectively. Accordingly, the adjustment member 330 may be moved along the extension direction of the bar member 310 while being coupled to the bar member 310.

The adjustment member 330 is coupled to the power unit 500. The adjustment member 330 and the power unit 500 may be fixedly coupled to move together. The coupling is achieved by the third coupling unit 430

The adjustment member 330 may be disposed to face the power unit 500 with the bar member 310 interposed therebetween. In the illustrated embodiment, the adjustment member 330 is located above the bar member 310, and the power unit 500 is located below the bar member 310.

In the illustrated embodiment, the adjustment member 330 includes an adjustment body 331, an adjustment guide 332, an adjustment dial 333, and an adjustment extension 334.

The adjustment body 331 forms an outer shape of the adjustment member 330. The adjustment body 331 covers the bar member 310 and is movably coupled to the bar member 310. In addition, the adjustment body 331 may be fixedly coupled to the power unit 500 to move together with the power unit 500.

The adjustment body 331 may be provided in any form that is movably coupled to the bar member 310 and fixedly coupled to the power unit 500 to move together. In the illustrated embodiment, the adjustment body 331 is provided in the form of a bracket.

In the above embodiment, the adjustment body 331 includes a first portion extending in the width direction while covering the bar member 310 from the upper side, a second portion extending in the height direction while covering the bar member 310 from the outside at each end of the first portion, and a third portion that is continuous with the second portion and extends outward in the width direction to be fixedly coupled to a motor bracket 512 of the power unit 500.

The adjustment body 331 is coupled to the adjustment guide 332. Specifically, the inner surface of the adjustment body 331 is provided with an adjustment guide 332 movably coupled to the bar hollows 311a and 312a. In an embodiment in which a plurality of second portions are provided, adjustment guides 332 may be provided on a pair of inner surfaces of the adjustment body 331 facing each other with the bar member 310 interposed therebetween.

The adjustment body 331 is coupled to the adjustment dial 333 and the adjustment extension 334. Specifically, the adjustment extension 334 is through-coupled to the first portion of the adjustment body 331. The adjustment extension 334 may be inserted into and coupled to the bar hollows 311a and 312a located on the upper side.

The adjustment body 331 is coupled to the motor bracket 512 of the power unit 500 by a third fastening member 432 of the third coupling unit 430. The adjustment body 331 may be fixedly coupled to the power unit 500 by the third fastening member 432.

The adjustment guide 332 is fixedly coupled to the adjustment body 331, and is movably coupled to the bar member 310. By the coupling, the adjustment body 331 and the power unit 500 coupled thereto may be moved along the extension direction of the bar member 310.

The adjustment guide 332 is movably inserted into and coupled to the bar hollows 311a and 312a formed in the bar member 310. The adjustment guide 332 may be moved along the extension direction of the bar hollows 311a and 312a, that is, along the front-rear direction in the illustrated embodiment.

The adjustment guide 332 is located on the surface of the inner surfaces of the adjustment body 331 facing the bar member 310 in the width direction, that is, on the inner surface of the second portion in the illustrated embodiment.

The adjustment guide 332 may have any shape that may be coupled to the adjustment body 331 and the bar member 310, respectively, and be moved together with the adjustment body 331. In the illustrated embodiment, the adjustment guide 332 includes a first extension coupled to the inner surface of the adjustment body 331, a second extension continuous with the first extension and extending toward the bar hollows 311a and 312a, and a third extension continuous with the second extension and extending in the height direction of the bar hollows 311a and 312a.

Therefore, it will be understood that the adjustment guide 332 may be inserted into and coupled to the bar hollows 311a and 312a through openings formed at each end in the extension direction of the bar hollows 311a and 312a.

In addition, the adjustment guide 332 is formed to extend in the extension direction of the bar member 310, that is, in the front-rear direction in the illustrated embodiment. In an embodiment, the extension length of the adjustment guide 332 may be the same as the extension length of the adjustment body 331 in the above direction, that is, in the front-rear direction.

The adjustment guide 332 may be formed of a synthetic resin material. This is to prevent excessive frictional force between the adjustment guide 332 and the bar member 310 when the adjustment body 331 and the power unit 500 coupled thereto are moved.

A plurality of adjustment guides 332 may be provided. The plurality of adjustment guides 332 may be coupled to the adjustment body 331 and the bar member 310 at different positions, respectively. In the illustrated embodiment, two adjustment guides 332 are provided to be coupled to the first bar hollow 311a formed on the left side of the first bar member 311 and the second bar hollow 312a formed on the right side of the second bar member 312, respectively.

The adjustment dial 333 is configured to adjust the coupling force between the adjustment body 331 and the bar member 310. The adjustment dial 333 may be operated by an external force so that the length of the adjustment extension 334 connected thereto is inserted into the bar hollows 311a and 312a may be adjusted.

The adjustment dial 333 is exposed to the outside of the adjustment body 331. An operator may adjust the adjustment dial 333 and the adjustment extension 334 coupled thereto by applying an external force to the exposed adjustment dial 333. In the illustrated embodiment, the adjustment dial 333 is positioned on the upper side of the adjustment body 331, that is, on the upper side of the first portion.

The adjustment dial 333 may be provided in any form that may be operated by an external force and moved in the height direction thereof, that is, in the up-down direction in the illustrated embodiment, together with the adjustment extension 334. In the illustrated embodiment, the adjustment dial 333 is provided to be rotatably operated to move toward the inside or outside of the adjustment body 331.

The adjustment dial 333 may be positioned vertically above the bar hollows 311a and 312a. Specifically, the adjustment dial 333 and the adjustment extension 334 coupled thereto may be located vertically above the bar hollows 311a and 312a, and may be inserted into or withdrawn from the bar hollows 311a and 312a in the height direction.

A plurality of adjustment dials 333 may be provided. The plurality of adjustment dials 333 may be spaced apart from each other and inserted into different bar hollows 311a and 312a formed in different bar members 310.

In the illustrated embodiment, two adjustment dials 333 are provided, and are disposed on the left and right sides. The adjustment dial 333 disposed on the left side is located above the first bar hollow 311a, and the adjustment dial 333 disposed on the right side is located above the second bar hollow 312a.

The adjustment dial 333 is coupled to the adjustment extension 334. The adjustment dial 333 may be moved in the up-down direction together with the adjustment extension 334.

The adjustment extension 334 is formed to extend in the height direction of the third support unit 300, that is, in the up-down direction in the illustrated embodiment.

One end in the extension direction of the adjustment extension 334, that is, the upper end in the illustrated embodiment, penetrates the adjustment body 331 and is coupled to the adjustment dial 333. The other end in the extension direction of the adjustment extension 334, that is, the lower end in the illustrated embodiment, is in contact with or spaced apart from the upper surface of the bar member 310 surrounding the bar hollows 311a and 312a from the lower side.

The adjustment extension 334 may be provided in any form capable of being raised and lowered together with the adjustment dial 333 and pressing the upper surface of the bar member 310 to maintain the position of the adjustment member 330. In the illustrated embodiment, the adjustment extension 334 has a cylindrical shape having a circular cross-section and extending in the up-down direction.

A plurality of adjustment extensions 334 may be provided. The plurality of adjustment extensions 334 may be disposed to be spaced apart from each other and coupled to the plurality of adjustment dials 333, respectively. In the illustrated embodiment, two adjustment extensions 334 are provided and positioned adjacent to the first bar hollow 311a and the second bar hollow 312a, respectively.

The coupling unit 400 couples the components of the draw in and out apparatus 31. The coupling unit 400 may detachably fix and couple the draw in and out apparatus 31. The coupling unit 400 may include a member connected to different components, respectively, and a member for coupling the member and the components. In an embodiment, the connecting member may be provided as a bracket or the like, and the coupling member may be provided as a bolt or a rivet or the like.

A plurality of coupling units 400 may be provided. The plurality of coupling units 400 may couple each component of the first support unit 100, the second support unit 200, and the third support unit 300, respectively. In addition, the plurality of coupling units 400 may movably couple the first support unit 100, the second support unit 200, the third support unit 300, and the power unit 500.

In the illustrated embodiment, the coupling unit 400 includes a first coupling unit 410, a second coupling unit 420, and a third coupling unit 430.

The first coupling unit 410 couples the components of the first support unit 100 to each other. A plurality of first coupling units 410 may be provided to couple each component of the first support unit 100 at a plurality of positions.

The first coupling unit 410 may include a member connecting each component of the first support unit 100, and a member for coupling the member and each component. In the illustrated embodiment, the first coupling unit 410 includes a first bracket 411 and a first fastening member 412.

The first bracket 411 is disposed to overlap each of the components of the first support unit 100 adjacent to each other. The first fastening member 412 is coupled to the first bracket 411 and the respective components, respectively, to fix and couple them.

The first bracket 411 may be provided in any form capable of combining each component of the first support unit 100. Referring to FIG. 11, the first bracket 411 for coupling the column member 110 with the magnet member 140 is provided in a flat plate shape. In addition, the first bracket 411, which combines the column member 110 and the plate member 120, is provided in a shape in which one bent portion is formed.

The second coupling unit 420 couples the components of the second support unit 200 to each other. A plurality of second coupling units 420 may be provided to couple each component of the second support unit 200 at a plurality of positions. In addition, the second coupling unit 420 may couple the second support unit 200 to the first support unit 100.

The second coupling unit 420 may include a member connecting each component of the second support unit 200, and a member for coupling the member and each component. In the illustrated embodiment, the second coupling unit 420 includes a second bracket 421 and a second fastening member 422.

The second bracket 421 is disposed to overlap each of the components of the second support unit 200 adjacent to each other. The second fastening member 422 is coupled to the second bracket 421 and the respective components, respectively, to fix and couple them.

In addition, the second bracket 421 may be disposed to overlap across the second support unit 200 and the first support unit 100, respectively. The second fastening member 422 may be coupled to the second bracket 421, the second support unit 200, and the first support unit 100, respectively, to fix and couple them.

The second bracket 421 may be provided in any form capable of coupling each component of the second support unit 200 or the second support unit 200 and the first support unit 100. Referring to FIGS. 12 to 14, the second bracket 421, which combines the beam member 210 and the partition wall member 220, is provided in a shape in which one bent portion is formed.

The third coupling unit 430 couples the components of the third support unit 300 to each other. A plurality of third coupling units 430 may be provided to couple each component of the third support unit 300 at a plurality of positions. In addition, the third coupling unit 430 may couple the third support unit 300 to the second support unit 200 and the power unit 500.

The third coupling unit 430 may include a member connecting each component of the third support unit 300, and a member for coupling the member and each component. In the illustrated embodiment, the third coupling unit 430 includes a third bracket 431 and a third fastening member 432.

The third bracket 431 is disposed to overlap each of the components of the third support unit 300 adjacent to each other. The third fastening member 432 is coupled to the third bracket 431 and the respective components, respectively, to fix and couple them.

In addition, the third bracket 431 may be disposed to overlap across the third support unit 300 and the second support unit 200 or the power unit 500, respectively. The second fastening member 422 may be coupled to the third bracket 431, the third support unit 300, the second support unit 200 or the power unit 500, respectively, to fix and couple them.

The third bracket 431 may be provided in any form capable of coupling each component of the second support unit 200 or the second support unit 200 and the first support unit 100. Referring to FIGS. 15 to 18, the third bracket 431 coupling the third support unit 300 and the second support unit 200 is formed to have one bent portion formed, and include a pair of flat plates continuous with the portion.

The power unit 500 is coupled to the circuit breaker 20 to provide power for drawing in or out the circuit breaker 20 to/from the distribution board housing 11. The coupling between the circuit breaker 20 and the distribution board housing 11 may be formed or released by the power unit 500.

The power unit 500 is coupled to the third support unit 300. The coupling may be achieved as the third fastening member 432 of the third coupling unit 430 couples the adjustment body 331 and the motor bracket 512. Specifically, the power unit 500 is fixedly coupled to the adjustment member 330, and is movably coupled to the bar member 310. The power unit 500 may be moved in a direction along the third axis a3 together with the adjustment member 330, that is, in the front-rear direction in the illustrated embodiment.

The power unit 500 is detachably coupled to the third support unit 300. That is, in the draw in and out apparatus 31, other components other than the power unit 500, that is, the first support unit 100, the second support unit 200, and the third support unit 300 may be pre-coupled to the distribution board housing 11, and then the power unit 500 may be coupled to the third support unit 300.

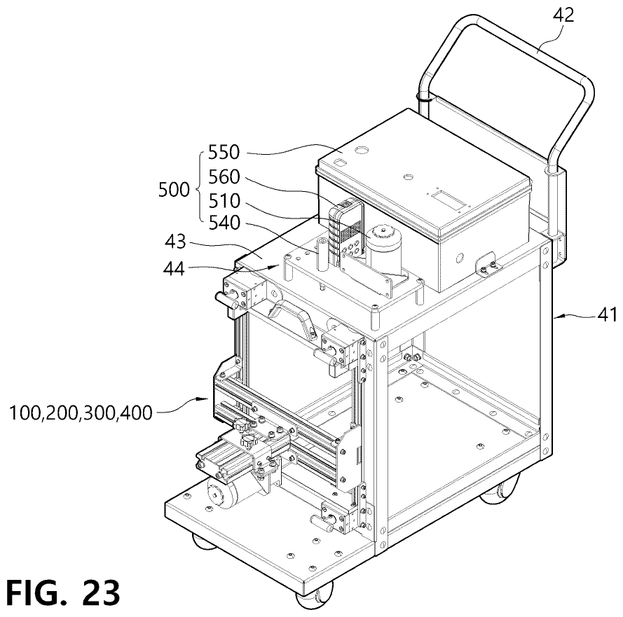

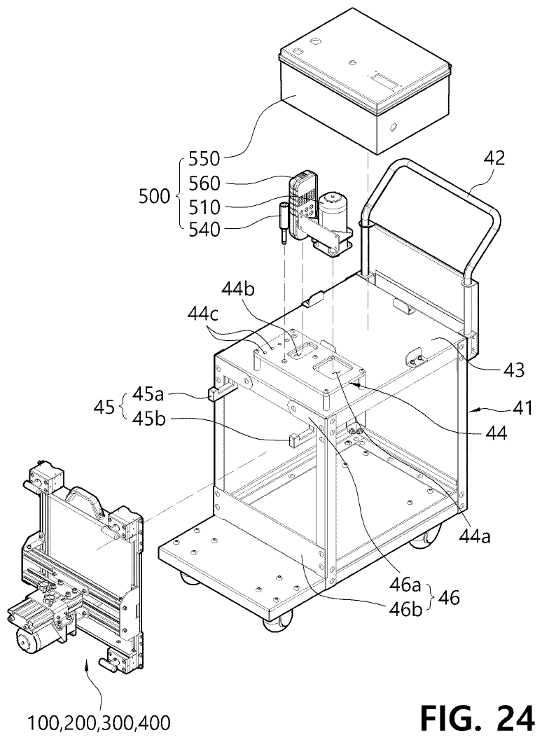

In addition, other components of the draw in and out apparatus 31 other than the power unit 500 and the power unit 500 may be moved or stored separately (see FIGS. 23 to 24). Therefore, the high-weight power unit 500 and the control power source (not shown) for controlling the power unit 500 may be moved and stored separately, thereby improving movement convenience.

The power unit 500 is positioned adjacent to the bar member 310 and is disposed to face the adjustment member 330 with the bar member 310 interposed therebetween. In the illustrated embodiment, the power unit 500 is located below the bar member 310.

In the illustrated embodiment, the power unit 500 includes a motor member 510, a gear box 520, a shaft 530, a key 540, a control device 550, and a remote controller 560.

The motor member 510 generates power for rotating the shaft 530 and the key 540. The motor member 510 is energized with an external control power source (not shown).

The motor member 510 is coupled to the gear box 520. By rotation of the motor member 510, one or more gears provided in the gear box 520 may be rotated. By the rotation, the shaft 530 and the key 540 are rotated so that the draw in and out apparatus 31 may be drawn into or drawn out from the distribution board housing 11.

The motor member 510 may be rotated clockwise or counterclockwise. When the motor member 510 is rotated in any one of the above directions, the circuit breaker 20 may be drawn into the distribution board housing 11. When the motor member 510 is rotated in the other one of the above directions, the circuit breaker 20 may be drawn out from the distribution board housing 11.

Whether the motor member 510 rotates, a rotation direction, a rotation speed, and the like may be controlled by the control device 550 or the remote controller 560. The motor member 510 is energized with the control device 550 and the remote controller 560.

In the illustrated embodiment, the motor member 510 includes a motor gear 511 and a motor bracket 512. The motor gear 511 is rotatably provided at one side in the extension direction of the motor member 510, that is, at the front side in the illustrated embodiment.

The motor bracket 512 is a portion where the power unit 500 is coupled to the adjustment member 330. The motor bracket 512 forms a part of the upper exterior of the motor member 510. The third fastening member 432 may pass through the motor bracket 512 to fix and couple the adjustment body 331 to the power unit 500.

The gear box 520 is positioned between the motor member 510 and the circuit breaker 20.

The gear box 520 receives rotation of the motor member 510 to rotate the shaft 530 and the key 540. The gear box 520 is located adjacent to the motor member 510, and is coupled to the motor member 510. In the illustrated embodiment, the gear box 520 is coupled to the rear side of the motor member 510.

The gear box 520 is coupled to the shaft 530. Rotation of one or more gears provided in the gear box 520 may be transferred to the shaft 530.

The shaft 530 is disposed to face the motor member 510 with the gear box 520 interposed therebetween. In the illustrated embodiment, the shaft 530 is located on the rear side of the gear box 520.

The shaft 530 is coupled to the key 540. Specifically, the shaft 530 is inserted into and coupled to a groove recessed inside the key 540 in the longitudinal direction. The shaft 530 may be rotated together with the key 540.

The key 540 is a portion where the power unit 500 is coupled to the circuit breaker 20. The key 540 may be inserted into and coupled to the apparatus insertion portion 22 of the circuit breaker 20. When the motor member 510 is operated to rotate the shaft 530 and the key 540, a member (not shown) provided in the apparatus insertion portion 22 may be also rotated to move the circuit breaker 20.

In this case, depending on the rotation direction of the key 540, the circuit breaker 20 may be moved in a direction of drawing out from the distribution board housing 11 (the front side in the illustrated embodiment) or in a direction of drawing into the distribution board housing 11 (the rear side in the illustrated embodiment).

The key 540 may be formed such that at least one plane is formed on an outer circumference thereof. Accordingly, an angle at which the key 540 is inserted into the apparatus insertion portion 22 may be limited. In addition, when the inserted key 540 is rotated, a member (not shown) provided in the apparatus insertion portion 22 may be rotated together with the key 540. In the illustrated embodiment, the key 540 is formed to have a hexagonal cross-section.

The control device 550 is energized with the motor member 510 to apply a control signal for controlling the rotation of the motor member 510. Rotation of the motor member 510 may be controlled by the control signal. In an embodiment, the control device 550 may be configured to apply power to the motor member 510. In the above embodiment, the control device 550 may include a battery or a component energized with an external control power source.

The control device 550 is energized with the remote controller 560. The control signal input to the remote controller 560 by an operator may be transmitted to the motor member 510 through the control device 550.

The control device 550 and the remote controller 560 may be separately provided. In other words, when the draw in and out apparatus 31 is coupled to the circuit breaker 20, the control device 550 and the remote controller 560 may be disposed to be spaced apart from the distribution board 10 or the circuit breaker 20. Therefore, an operator may remotely perform a drawing-in operation or a drawing-out operation of the circuit breaker 20.

### (2) Description of the Draw in and Out Apparatus 32 According to Another Exemplary Embodiment of the Present Disclosure

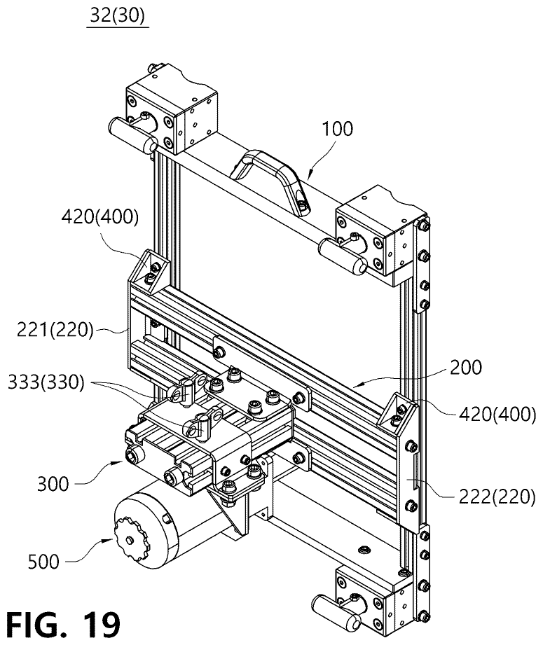

Referring to FIG. 19, a draw in and out apparatus 32 according to another exemplary embodiment of the present disclosure is shown.

The draw in and out apparatus 32 according to the present embodiment has some differences in the shape of the partition wall member 220, the shape of the adjustment dial 333, and the shape of the second coupling unit 420 compared to the draw in and out apparatus 31 according to the above-described embodiment.

In addition, the functions of the partition wall member 220, the adjustment dial 333, and the second coupling unit 420 and the coupling structure with other components are the same as those of the draw in and out apparatus 31 according to the above-described embodiment. Furthermore, the configuration, structure, and function of the draw in and out apparatus 32 are the same as those of the draw in and out apparatus 31 according to the above-described embodiment.

Accordingly, hereinafter, the draw in and out apparatus 32 according to the present embodiment will be described, focusing on the shape of the partition wall member 220, the adjustment dial 333, and the second coupling unit 420.

The partition wall member 220 according to the present embodiment is formed to have a rhombus-shaped cross-section. In this case, the height of the cross-section of the partition wall member 220 is formed shorter than that of the partition wall member 220 of the draw in and out apparatus 31 according to the above embodiment.

In addition, the adjustment dial 333 according to the present embodiment is configured to include a plurality of protrusions facing each other. Accordingly, the cross-section of the adjustment dial 333 according to the present embodiment has a shape of a butterfly.

Furthermore, the second coupling unit 420 according to the present embodiment has a triangular cross-section and extends in the width direction thereof, that is, in the left-right direction in the illustrated embodiment, and a space communicating with the outside is formed therein. In this case, the shape of the cross-section of the second coupling unit 420 may be formed to correspond to the shape of the end of the cross-section of the partition wall member 220.

Like the draw in and out apparatus 32 according to another exemplary embodiment of the present disclosure described above, it will be understood that the structure of the draw in and out apparatus 30 according to an exemplary embodiment of the present disclosure can be changed in various forms as long as its functions and effects are maintained.

### (3) Description of an Operation Process of the Draw in and Out Apparatus 30 According to an Exemplary Embodiment of the Present Disclosure

Referring to FIGS. 20 to 22, a process in which the draw in and out apparatus 30 according to an exemplary embodiment of the present disclosure is operated and the relative position of the distribution board 10 or the circuit breaker 20 is adjusted is illustrated.

As described above, the draw in and out apparatus 30 according to an exemplary embodiment of the present disclosure may be provided such that the power unit 500 coupled to the circuit breaker 20 is movable along at least one of the first axis a1, the second axis a2, and the third axis a3. In an embodiment, the first axis a1, the second axis a2, and the third axis a3 may be defined as each axis of a three-dimensional orthogonal coordinate system.

Therefore, the power unit 500 may be moved in a three-dimensional space and adjusted to a position where the key 540 may be inserted into the apparatus insertion portion 22 of the circuit breaker 20.

Referring to FIG. 20, a process in which the power unit 500 is moved along the first axis a1 is illustrated. The first axis a1 may be defined as the vertical direction. Thus, in an embodiment in which the first to third axes a1, a2, and a3 are defined as respective axes of the three-dimensional orthogonal coordinate system, the first axis a1 may be defined as the Z axis.

Referring to FIG. 20(a), an example in which the power unit 500 is moved upward along the first axis a1 is shown. In addition, referring to FIG. 20(b), an example in which the power unit 500 is moved downward along the first axis a1 is shown. It will be understood that the above process is performed by elevating the second support unit 200 to which the power unit 500 is coupled (i.e., via the third support unit 300) along the column member 110.

When the power unit 500 reaches a preset position in a direction along the first axis a1, the second support unit 200 and the column member 110 may be fixedly coupled by the second fastening member 422 of the second coupling unit 420. Accordingly, the power unit 500 may also be maintained at the corresponding position.

Referring to FIG. 21, a process in which the power unit 500 is moved along the second axis a2 is illustrated. The second axis a2 may be defined as one of horizontal directions. In an embodiment in which the first to third axes a1, a2, and a3 are defined as respective axes of the three-dimensional orthogonal coordinate system, the second axis a2 may be defined as one of the X axis or the Y axis.

Referring to FIG. 21(a), an example in which the power unit 500 is moved to the left along the second axis a2 is shown. In addition, referring to FIG. 22(b), an example in which the power unit 500 is moved to the right along the second axis a2 is shown. It will be understood that the above process is performed by moving the third support unit 300 to which the power unit 500 is coupled, along the beam member 210.

When the power unit 500 reaches a preset position in a direction along the second axis a2, the second support unit 200 and the beam member 210 may be fixedly coupled by the second fastening member 422 of the second coupling unit 420. Accordingly, the power unit 500 may also be maintained at the corresponding position.

Referring to FIG. 22, a process in which the power unit 500 is moved along the third axis a3 is illustrated. The third axis a3 may be defined as the other of horizontal directions. In an embodiment in which the first to third axes a1, a2, and a3 are defined as respective axes of the three-dimensional orthogonal coordinate system, the third axis a3 may be defined as the other of the X axis or the Y axis.

Referring to FIG. 22(a), an example in which the power unit 500 is moved forward along the third axis a3 is shown. This is a direction in which the key 540 of the power unit 500 is drawn out from the apparatus insertion portion 22 of the circuit breaker 20.

In addition, referring to FIG. 22(b), an example in which the power unit 500 is moved backward along the third axis a3 is shown. This is a direction in which the key 540 of the power unit 500 is drawn into the apparatus insertion portion 22 of the circuit breaker 20.

It will be understood that the above process is performed by moving the adjustment member 330 to which the power unit 500 is coupled, along the bar member 310.

When the power unit 500 reaches a preset position in a direction along the third axis a3, the adjustment member 330 and the bar member 310 may be fixedly coupled by the third fastening member 432 of the third coupling unit 430. Accordingly, the power unit 500 may also be maintained at the corresponding position.

The movement process of the power unit 500 described above may be performed simultaneously or at different times. Therefore, the power unit 500 may be moved in various directions and positioned to fit the circuit breaker 20, and then coupled to the circuit breaker 20.

Therefore, the position of the power unit 500 may be more accurately adjusted, so that the coupling of the power unit 500 and the circuit breaker 20 may be reliably performed. As a result, the process of drawing in and out of the circuit breaker 20 may also be stably performed.

### 4. Description of a Cart Apparatus 40 According to an Exemplary Embodiment of the Present Disclosure

Referring back to FIGS. 23 to 24, a cart apparatus 40 according to an exemplary embodiment of the present disclosure is shown.

The cart apparatus 40 may be moved while loading the draw in and out apparatus 30. Therefore, an operator can load the high-weight draw in and out apparatus 30 on the cart apparatus 40 and move it without having to directly grip and move it. Although a reference numeral is not given, the cart apparatus 40 may be moved by being supported by a plurality of wheels rotatably provided at the lower side.

Therefore, an operator can easily move the draw in and out apparatus 30 and the cart apparatus 40 equipped with it by pushing or pulling the cart apparatus 40 without applying excessive force.

As described above, in the draw in and out apparatus 30 according to an exemplary embodiment of the present disclosure, each component, for example, the first support unit 100, the second support unit 200, the third support unit 300, the coupling unit 400, and the power unit 500 may be detachably coupled to each other.

Therefore, the draw in and out apparatus 30 may be configured to be loaded on the cart apparatus 40 with at least one of its components separated and then moved and assembled before being installed on the distribution board 10 or circuit breaker 20.

In the illustrated embodiment, in the draw in and out apparatus 30, the first support unit 100, the second support unit 200, the third support unit 300, and the coupling unit 400 are maintained in a coupled state, but the power unit 500 is separated and loaded on the cart apparatus 40. This is due to the fact that the power unit 500 is relatively high in weight compared to other components of the draw in and out apparatus 30.

Alternatively, it may be configured that all components of the draw in and out apparatus 30 are loaded on the cart apparatus 40 in a separated state and moved. In this case, the cart apparatus 40 may be provided with additional components for stably supporting each separated component of the draw in and out apparatus 30.

In the illustrated embodiment, the cart apparatus 40 includes a cart body 41, a cart handle 42, a support plate 43, a utility accommodation portion 44, an apparatus support portion 45, and an apparatus coupling portion 46.

The cart body 41 forms an outer shape of the cart apparatus 40. The cart handle 42, the support plate 43, the utility accommodation portion 44, the apparatus support portion 45, and the apparatus coupling portion 46 are coupled to the cart body 41.

The cart body 41 may have any shape capable of loading and moving components of the draw in and out apparatus 30. In the illustrated embodiment, the cart body 41 has a quadrangular pillar shape in which the extension length in the front-rear direction is longer than the extension length in the left-right direction, with a height in the up-down direction.

In this case, multiple wheels are rotatably provided on the lower side of the cart body 41, so that the cart apparatus 40 can be rolled and moved by external force.

The cart handle 42 is provided on one side in the longitudinal direction of the cart body 41, that is, on the rear side in the illustrated embodiment.

The cart handle 42 is a portion gripped by an operator. The cart handle 42 includes a bar portion extending in the width direction of the cart body 41, that is, in the left-right direction in the illustrated embodiment. An operator may move the cart apparatus 40 by gripping the bar portion.

In an embodiment, the cart handle 42 may be configured such that the height thereof, i.e., the length in the up-down direction, is adjusted in the illustrated embodiment.

One of the surfaces of the cart body 41 opposite to the ground, that is, the upper surface in the illustrated embodiment, may be defined as the support plate 43.

The support plate 43 supports components of the power unit 500 among the components of the draw in and out apparatus 30. The support plate 43 may form the upper surface of the cart body 41, so that the components of the power unit 500 may be seated on the support plate 43.

A plurality of ribs (reference numeral not indicated) may be formed on the support plate 43. The plurality of ribs may support components of the power unit 500 seated on the support plate 43 at different positions. In the illustrated embodiment, the plurality of ribs are positioned at the rear side to support the control device 550 in the horizontal direction.

The utility accommodation portion 44 is seated on the support plate 43.

The utility accommodation portion 44 accommodates relatively small components among the components of the power unit 500. The utility accommodation portion 44 may be disposed adjacent to the control device 550 seated on the support plate 43. In the illustrated embodiment, the utility accommodation portion 44 is positioned on the front side of the control device 550.

The utility accommodation portion 44 may include a plate member including a plurality of openings and a plurality of support portions supporting the plate member. In the illustrated embodiment, the utility accommodation portion 44 includes first to third openings 44a, 44b, and 44c.

The first opening 44a accommodates and supports the motor member 510 of the power unit 500. The second opening 44b accommodates and supports the remote controller 560, and the third opening 44c accommodates and supports the key 540. In this case, the motor member 510 may be maintained in a state of being coupled to the gear box 520 and the shaft 530.

Therefore, the high-weight power unit 500 may be loaded on the cart apparatus 40 and moved in a state separated into a plurality of components.

The apparatus support portion 45 supports other components of the draw in and out apparatus 30 except for the power unit 500. The apparatus support portion 45 is formed to extend from one side of the cart body 41, that is, from the upper side of the front side in the illustrated embodiment. The apparatus support portion 45 is configured to support the first plate member 121 from the lower side by penetrating the accommodation opening 130.

The outer end in the extension direction of the apparatus support portion 45, that is, the front end in the illustrated embodiment, has a portion protruding upward. The protruding portion is configured to surround the first plate member 121 from the front side. Accordingly, arbitrary separation of the draw in and out apparatus 30 (i.e., excluding the power unit 500) seated on the apparatus support portion 45 may be prevented.

A plurality of apparatus support portions 45 may be provided. The plurality of apparatus support portions 45 may be spaced apart from each other in the width direction to support the draw in and out apparatus 30 at a plurality of positions. In the illustrated embodiment, two apparatus support portions 45 are provided, including a first apparatus support portion 45a on the left and a second apparatus support portion 45b on the right, and are positioned adjacent to each end in the extension direction of the first plate member 121.

The apparatus coupling portion 46 is provided adjacent to the apparatus support portion 45.

The apparatus coupling portion 46 is a portion to which the draw in and out apparatus 30 seated on the apparatus support portion 45 is coupled. As described above, the draw in and out apparatus 30 may be coupled to the distribution board housing 11 by a magnetic force formed by the magnet member 140.

The apparatus coupling portion 46 provided in the cart apparatus 40 may also be configured to be coupled by a magnetic force formed by the magnet member 140. In the above embodiment, since an additional component for coupling the draw in and out apparatus 30 to the cart apparatus 40 is not required, the structure of the draw in and out apparatus 30 or the cart apparatus 40 may be simplified.

To this end, the apparatus coupling portion 46 may be formed of a material that may be magnetized by a magnetic force. In an embodiment, the apparatus coupling portion 46 may be formed of iron (Fe) or an alloy material including iron. In addition, it is preferable that the apparatus coupling portion 46 is formed in a shape in which the contact area of the magnet member 140 can be sufficiently secured.

A plurality of apparatus coupling portions 46 may be provided. The plurality of apparatus coupling portions 46 may be respectively coupled to the magnet member 140 at different positions. In this case, the arrangement method of the plurality of apparatus coupling portions 46 is preferably determined according to the positions of the first to third magnet members 141, 142 and 143.

In the illustrated embodiment, the apparatus coupling portion 46 includes a first apparatus coupling portion 46a positioned on the upper side and coupled to the first magnet member 141 and the third magnet member 143, respectively, and a second apparatus coupling portion 46b positioned on the lower side and coupled to the second magnet member 142.

In this case, a plurality of first apparatus coupling portions 46a are provided and are spaced apart from each other in the width direction, that is, in the left-right direction in the illustrated embodiment. The first apparatus coupling portion 46a on the left is coupled to the first magnet member 141, and the first apparatus coupling portion 46a on the right is coupled to the third magnet member 143.

In the illustrated embodiment, the first apparatus coupling portion 46a includes a single bent portion, and includes a pair of edges and a vertex at which the pair of edges are continuous. That is, in the above embodiment, the first apparatus coupling portion 46a is provided as a plate-shaped bracket.

In addition, in the illustrated embodiment, the second apparatus coupling portion 46b is provided in a plate shape extending in the width direction, that is, in the left-right direction. The shape of the second apparatus coupling portion 46b may be an arbitrary shape that may be coupled to the second magnet member 142.

As described above, other components of the draw in and out apparatus 30 other than the power unit 500 may be supported by and coupled to the apparatus support portion 45 and the apparatus coupling portion 46. In addition, the power unit 500 may be accommodated in the support plate 43 and the utility accommodation portion 44. As a result, the draw in and out apparatus 30 may be moved while the power unit 500 is separated, thereby improving transport convenience.

Although exemplary embodiments of the present disclosure have been described, the idea of the present disclosure is not limited to the embodiments set forth herein. Those of ordinary skill in the art who understand the idea of the present disclosure may easily propose other embodiments through supplement, change, removal, addition, etc. of elements within the same idea, but the embodiments will be also within the scope of the present disclosure.

| | |
|---|---|
| 10: distribution board | 11: distribution board housing |
| 12: apparatus coupling portion | 20: circuit breaker |
| 21: break button | 22: insertion space |
| 30: draw in and out apparatus | |
| 31: draw in and out apparatus according | |
| to an exemplary embodiment of the present | |
| disclosure | |
| 32: draw in and out apparatus according | |
| to another exemplary embodiment of the | |
| present disclosure | |
| 40: cart apparatus | 41: cart body |
| 42: cart handle | 43: support plate |
| 44: utility accommodation portion | 44a: first opening |
| 44b: second opening | 44c: third opening |
| 45: apparatus support portion | 45a: first apparatus support portion |
| 45b: second apparatus support portion | 46: apparatus coupling portion |
| 46a: first apparatus coupling portion | |
| 46b: second apparatus coupling portion | |
| 100: first support unit | 110: column member |
| 111: first column member | 111a: first column hollow |
| 112: second column member | 112a: second column hollow |
| 120: plate member | 121: first plate member |
| 122: second plate member | 130: accommodation opening |
| 140: magnet member | 141: first magnet member |
| 142: second magnet member | 143: third magnet member |
| 150: handle member | 151: first handle member |
| 152: second handle member | 153: third handle member |
| 160: gripping member | 200: second support unit |
| 210: beam member | 211: first beam member |
| 211a: first beam hollow | 212: second beam member |
| 212a: second beam hollow | 220: partition wall member |
| 221: first partition wall member | 221a: first bent portion |
| 222: second partition wall member | 222a: second bent portion |
| 300: third support unit | 310: bar member |
| 311: first bar member | 311a: first bar hollow |
| 312: second bar member | 312a: second bar hollow |
| 320: support member | 321: first support member |
| 322: second support member | 330: adjustment member |
| 331: adjustment body | 332: adjustment guide |
| 333: adjustment dial | 334: adjustment extension |
| 400: coupling unit | 410: first coupling unit |
| 411: first bracket | 412: first fastening member |
| 420: second coupling unit | 421: second bracket |
| 422: second fastening member | 430: third coupling unit |
| 431: third bracket | 432: third fastening member |
| 500: power unit | 510: motor member |
| 511: motor gear | 512: motor bracket |
| 520: gear box | 530: shaft |
| 540: key | 550: control device |
| 560: remote controller | a1: first axis |
| a2: second axis | a3: third axis |
| d1: first separation distance | d2: second separation distance |
| d3: third separation distance | t1: first thickness |
| t2: second thickness | |

1. A draw in and out apparatus, the apparatus comprising:
a first support unit detachably coupled to an external distribution board;
a second support unit movably coupled to the first support unit;
a third support unit movably coupled to the second support unit; and
a power unit detachably coupled to the third support unit, and configured to be coupled to or detachable from an external circuit breaker,
wherein the power unit comprises:
a key withdrawably accommodated in an insertion space provided in the circuit breaker; and
a motor member coupled to the key and configured to rotate the inserted key in any one direction of the clockwise direction and counterclockwise direction.

2. The apparatus of claim 1,
wherein the third support unit comprises:
a bar member that is movably coupled to the second support unit and formed to extend along one direction; and
an adjustment member movably coupled to the bar member and to which the power unit is fixedly coupled, and
wherein the power unit is coupled to the bar member to be movable along the one direction together with the adjustment member.

3. The apparatus of claim 2,
wherein the adjustment member comprises:
an adjustment body arranged to face the power unit with the bar member therebetween and fixedly coupled to the power unit; and
an adjustment guide disposed on the inner surface of the adjustment body and movably inserted into one of a plurality of bar hollows formed in the bar member.

4. The apparatus of claim 3, comprising a fastening member that detachably connects the adjustment body and the power unit.

5. The apparatus of claim 3,
wherein the adjustment member comprises:
an adjustment extension penetrating the adjustment body and extending to another one of the plurality of bar hollows; and
an adjustment dial coupled to the adjustment extension, exposed to the outside of the adjustment body, and rotatably provided so as to move together with the adjustment extension in a direction toward the bar hollow and in a direction opposite to the bar hollow.

6. The apparatus of claim 1,
wherein the first support unit comprises:
a column member surrounding a portion of the circuit breaker accommodated in the distribution board;
a plate member coupled to the column member and surrounding another portion of the circuit breaker; and
a magnet member that is coupled to the plate member and forms a magnetic force so as to be detachably coupled to the distribution board.

7. The apparatus of claim 6,
wherein the first support unit comprises:
a handle member coupled to the magnet member and configured to adjust the magnitude of a magnetic force formed by the magnet member by being operated by an external force.

8. The apparatus of claim 7,
wherein when the handle member is rotated in any one direction of the clockwise direction and the counterclockwise direction, the magnitude of the magnetic force formed by the magnet member increases, so that the magnet member is coupled to the distribution board, and
when the handle member is rotated in the other direction of the clockwise direction and the counterclockwise direction, the magnitude of the magnetic force formed by the magnet member decreases, so that the magnet member is separated from the distribution board.

9. The apparatus of claim 6,
wherein a pair of said column members are provided, and the pair of column members are disposed to be spaced apart from each other, and
wherein the plate member is formed to extend as far as a distance at which the pair of column members are spaced apart.

10. The apparatus of claim 6,
wherein the second support unit comprises:
a partition wall member movably coupled to the column member; and
a beam member that is coupled to the partition wall member to move together with the partition wall member and movably supports the third support unit.

11. The apparatus of claim 10,
wherein a pair of said beam members are provided, and the pair of beam members are disposed to be spaced apart from each other, and
wherein the partition wall member is formed to extend as far as a distance at which the pair of beam members are spaced apart.

12. The apparatus of claim 10,
wherein the third support unit comprises:
a bar member movably coupled to the beam member and extending in a direction opposite to the circuit breaker; and
a support member coupled to an end in the extension direction of the bar member.

13. The apparatus of claim 12,
wherein a pair of said bar members are provided, and the pair of bar members are disposed to be spaced apart from each other, and
wherein the support member is formed to extend as far as a distance at which the pair of bar members are spaced apart.

14. A cart apparatus configured to be moved with loading a plurality of support units and a power unit that is detachably coupled to one of the plurality of support units, the cart apparatus comprising:
a cart body;
a support plate forming one side of the cart body and supporting the power unit; and
an apparatus support portion formed to extend outward from the other side of the cart body and penetrate through the plurality of support units coupled to each other to support a portion thereof.

15. The cart apparatus of claim 14,
wherein the power unit comprises:
a motor member;
a key coupled to the motor member to rotate together; and
a remote controller configured to be energized with the motor member and to receive a control signal, and
wherein a utility accommodation portion in which a plurality of openings are formed through which the motor member, the key, and the remote controller pass, respectively, is disposed in the support plate.
